(19) United States
(12) Patent Application Publication
(10) Pub. No.: US 2014/0140467 A1
(43) Pub. Date: May 22, 2014

(54) PRESSURIZED WATER REACTOR WITH INTERNAL REACTOR COOLANT PUMP SYSTEM

(71) Applicant: Babcock & Wilcox Power Generation Group, Inc., Barberton, OH (US)

(72) Inventor: Robert T FORTINO, Canton, OH (US)

(21) Appl. No.: 13/863,453

(22) Filed: Apr. 16, 2013

Related U.S. Application Data
(60) Provisional application No. 61/624,425, filed on Apr. 16, 2012.
(60) Provisional application No. 61/624,966, filed on Apr. 16, 2012.

(51) Int. Cl. G21C 1/32

(52) U.S. Cl. CPC G21C 1/32
USPC 376/395; 376/361

(57) ABSTRACT

A pressurized water reactor (PWR) includes a pressure vessel containing a radioactive core immersed in primary coolant water. A reactor coolant pump (RCP) disposed in a downcomer annulus of the PWR includes a jet pump and an electric pump whose impeller is disposed at the jet pump injector inlet. The electric pump includes a canned electric motor that is disposed in the downcomer annulus. In another RCP embodiment, the jet pump is omitted and the electric pump is seated in a flow distributor with the impeller of the seated RCP disposed in an impeller plenum defined by the flow distributor. The flow distributor further defines a fluid flow path with one or more branches extending from an inlet and running alongside but not through the canned electric motor of the seated RCP to discharge into the impeller plenum containing the impeller of the seated RCP.

This application claims the benefit of U.S. Provisional Application No. 61/624,425 filed Apr. 16, 2012 and titled “PRESSURIZED WATER REACTOR WITH REACTOR WITH INTERNAL REACTOR COOLANT PUMP SYSTEM”. U.S. Provisional Application No. 61/624,425 filed Apr. 16, 2012 and titled “PRESSURIZED WATER REACTOR WITH REACTOR WITH INTERNAL REACTOR COOLANT PUMP SYSTEM” is hereby incorporated by reference in its entirety into the specification of this application.

This application claims the benefit of U.S. Provisional Application No. 61/624,966 filed Apr. 16, 2012 and titled “COOLANT PUMP APPARATUSES AND METHODS OF USE FOR SMRS”. U.S. Provisional Application No. 61/624,966 filed Apr. 16, 2012 and titled “COOLANT PUMP APPARATUSES AND METHODS OF USE FOR SMRS” is hereby incorporated by reference in its entirety into the specification of this application.

### BACKGROUND

The following relates to the nuclear reactor arts, nuclear power generation arts, nuclear reactor hydrodynamic design arts, and related arts.

In nuclear reactor designs of the pressurized water reactor (PWR) type, a radioactive nuclear reactor core is immersed in primary coolant water at or near the bottom of a pressure vessel. The primary coolant is maintained in a compressed or subcooled liquid phase. In applications in which steam generation is desired, the primary coolant water is flowed out of the pressure vessel, into an external steam generator where it heats secondary coolant water flowing in a separate secondary coolant path, and back into the pressure vessel. However, this approach has the disadvantage of introducing large-diameter vessel penetrations for flowing primary coolant to and from the steam generator.

An alternative design is an “integral” PWR, in which an internal steam generator is located inside the pressure vessel. In the integral PWR design, the secondary coolant is flowed into the pressure vessel within a separate secondary coolant path in the internal steam generator. Effectively, the large vessel penetrations flowing primary coolant are replaced by typically smaller vessel penetrations for flowing non-radioactive secondary coolant feedwater into the pressure vessel and non-radioactive secondary coolant steam out of the pressure vessel.

The integral PWR design introduces a new issue, namely circulation of the primary coolant. In a conventional (i.e., external steam generator) PWR design, reactor coolant pumps can be located externally to drive primary coolant through the primary coolant circuit between the pressure vessel and the external steam generator. The integral PWR eliminates this external primary coolant flow circuit. Natural primary coolant circulation is not usually sufficient in integral PWR electrical plant designs for reasonably high electrical power output, e.g. of order 100 MW_{elec} or higher. A solution is to provide reactor coolant pumps (RCPs) actively pumping the primary coolant in the pressure vessel. Internal RCPs would be convenient, but the difficult thermal, chemical, and radioactive environment inside the pressure vessel makes construction of robust and reliable internal RCPs challenging. External RCPs avoid these difficulties but require vessel penetrations and piping or flanging in order to couple the external RCPs with the primary coolant inside the pressure vessel.

In addition to robustness and reliability of the RCPs, another consideration is effectiveness in providing uniform primary coolant circulation. The RCPs are discrete components each providing localized pumping proximate to the RCP. An assembly of such RCPs provides approximately uniform circulation, but some flow variation is expected to remain. In practice, the impellers of the RCPs typically generate a large but relatively spatially nonuniform pressure head.

In the case of boiling water reactor (BWR) designs, a known configuration is to employ a jet pump internal to the BWR pressure vessel. In this design, the jet pump is located in the downcomer annulus and discharges into a lower primary coolant inlet that feeds primary coolant to the bottom of the reactor core. The goal is not merely to circulate primary coolant, but to facilitate mixing of primary coolant within the downcomer annulus volume (i.e., recirculation of primary coolant). Toward this end, primary coolant is piped out of the lower end of the downcomer annulus and flowed through external piping back into the pressure vessel at an elevated vessel penetration to feed into the upper suction end of the jet pump. In this design the jet pump has a height that is comparable with the height of the downcomer annulus, and so the mixing chamber of the jet pump mixes primary coolant from the lower end of the downcomer annulus (fed in through the external piping) with primary coolant from the upper end of the downcomer annulus that enters via the suction inlet of the jet pump. Some illustrative examples of BWR designs employing such a recirculating jet pump are described in Roberts, U.S. Pat. No. 3,378,456 (issued Apr. 16, 1968) and Joseph, Intl Appl. No. WO 2011/035043 A1 (published Mar. 24, 2011).

While providing effective primary coolant recirculation in the BWR context, this design has some disadvantages. The external primary coolant flow circuit presents safety issues and increases cost and hardware. The long jet pump diffuser is also relatively fragile and is prone to cracking due to vibrations, thermal stress, or the like. In an integral PWR design, the internal steam generator is typically located in the downcomer annulus, making it difficult or impossible to also include the recirculating jet pump of the BWR design. Moreover, the goal in a PWR is not recirculation within the downcomer annulus, but rather uniform downward circulation of primary coolant.

Disclosed herein are improvements that provide various benefits that will become apparent to the skilled artisan upon reading the following.

### BRIEF SUMMARY

In one aspect of the disclosure, an apparatus comprises an integral pressurized water reactor (PWR) and a reactor coolant pump (RCP). The integral PWR includes a cylindrical pressure vessel, a cylindrical central riser disposed coaxially inside the cylindrical pressure vessel wherein a downcomer annulus is defined between the cylindrical central riser and the cylindrical pressure vessel, a nuclear core comprising a fissile material, and a steam generator disposed in the downcomer annulus. The RCP includes a jet pump disposed in the downcomer annulus above or below the steam generator, and a hydraulic pump configured to pump primary coolant into a nozzle of the jet pump wherein the hydraulic pump includes an electric motor mounted internally to the pressure vessel.

In another aspect of the disclosure, an alternative RCP which does not use a jet pump is disclosed. The RCP is mounted in a flow distributor mounted to a pump plate.

In another aspect of the disclosure, a reactor coolant pump (RCP) includes (i) a jet pump having an injector inlet, a pump inlet, and a diffuser with a jet pump discharge and (ii) an electrically driven hydraulic pump including an impeller disposed at the injector inlet and an electric motor connected with the impeller by a drive shaft. In some such embodiments, the drive shaft lies along a centerline of the jet pump passing from the injector inlet to the jet pump discharge. The impeller is suitably disposed along the centerline of the jet pump between the injector inlet and the electric motor.

In another aspect of the disclosure, a reactor coolant pump (RCP) includes an impeller and an electric motor connected with the impeller by a drive shaft, and a flow distributor defines an impeller plenum and a fluid flow path. The RCP is seated in the flow distributor with the impeller of the seated RCP disposed in the impeller plenum and with the fluid flow path extending from a fluid flow inlet to the impeller plenum wherein the fluid flow path passes alongside but not through the electric motor of the seated RCP. The fluid flow path optionally includes a plurality of branches passing alongside but not through the electric motor of the seated RCP and connecting with the impeller plenum at different locations around the impeller.

In another aspect of the disclosure, a nuclear reactor includes a nuclear core comprising fissile material disposed in a pressure vessel and immersed in primary coolant water, and an RCP as set forth in either one of the two immediately preceding paragraphs, wherein the electric motor of the RCP is a canned electric motor that is disposed inside the pressure vessel and immersed in primary coolant water.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a nuclear reactor including reactor coolant pumps (RCPs) comprising jet pumps driven by hydraulic pumps with internally mounted motors as disclosed herein.

FIG. 2 diagrammatically shows a perspective isolation view of one of the electrically driven hydraulic pumps with attached jet pump of FIG. 1.

FIG. 3 diagrammatically shows a cutaway view of the downcomer section of the pressure vessel of FIG. 1.

FIG. 4 diagrammatically shows a perspective view of reactor coolant pumps including jet pumps mounted to an annular pump plate.

FIG. 5 shows the diffuser section of a jet pump of a reactor coolant pump.

FIG. 6 shows the diffuser section of FIG. 5 in phantom to illustrate the vanes and nozzle of the diffuser section.

FIG. 7 shows an arcuate segment of the pump plate of FIG. 4.

FIG. 8 shows the internal flow diverter of the pump plate of FIG. 7.

FIG. 9 shows a view of the mid-flange of the pressure vessel of FIG. 1.

FIG. 10 shows an exemplary electrical and coolant connector in phantom for the reactor coolant pump of FIG. 2.

FIG. 11 shows the exterior of the exemplary electrical and coolant connector of FIG. 10.

FIG. 12 diagrammatically shows a perspective view of the electric motor portion of the reactor coolant pump with electrical and coolant lines.

FIG. 13 shows the reactor coolant pump with housing removed mounted in the downcomer of the pressure vessel of FIG. 1 as well as electrical and coolant penetrations in the vessel.

FIG. 14 diagrammatically shows a perspective view in partial section of the jet pumps of FIG. 2 mounted on the pump plate of FIG. 7.

FIG. 15 diagrammatically shows the mid-flange of the pressure vessel of FIG. 1 to illustrate an alternate method of electrically connecting the reactor coolant pumps.

FIG. 16 shows reactor coolant pumps in the downcomer of the vessel of FIG. 1 to illustrate the alternate method of electrically connecting the reactor coolant pumps.

FIG. 17 is a cutaway of the reactor vessel of FIG. 1 to illustrate the alternate connection method.

FIG. 18 depicts a manway cover on the exterior of the pressure vessel of FIG. 1 to illustrate the alternate connection method

FIG. 19 depicts the same location on the pressure vessel as FIG. 18 with the manway cover removed.

FIG. 20 shows the electric motor portion of the reactor coolant pump with the vessel penetrations of the alternate connection method.

FIG. 21 diagrammatically shows the reactor coolant pump with jet pump and electrical and coolant connectors of the alternate connection method.

FIG. 22 shows the electric motor portion with motor head cover removed of FIG. 21.

FIG. 23 shows a cutaway view of the mid-flange of the pressure vessel of FIG. 1 with an alternate embodiment of the reactor coolant pump which does not use a jet pump.

FIG. 24 diagrammatically shows a perspective view of the mid-flange of the pressure vessel of FIG. 1 showing the alternate embodiment of reactor coolant pumps not having jet pumps.

FIG. 25 diagrammatically shows another perspective view of the mid-flange of FIG. 24.

FIG. 26 diagrammatically shows the mid-flange of FIG. 24 with the reactor coolant pumps removed from the pump plate.

FIG. 27 diagrammatically shows an overhead view of the mid-flange of FIG. 24.

FIG. 28 shows the reactor coolant pump without jet pump mounted in a flow distributor.

FIG. 29 shows the reactor coolant pump of FIG. 28 without flow distributor.

FIGS. 30 and 31 are different perspective views of the flow diverter of FIG. 28.

FIG. 32 is a view of the reactor coolant pump of FIG. 28 with cover removed to show insulation.

FIGS. 33 is a cutaway view of the lower impeller housing of the reactor coolant pump embodiment of FIG. 2 (with jet pump) illustrating the bearings.

FIGS. 34 and 35 depict the housing of FIG. 33 in a startup and normal running configuration, respectively.

FIG. 36 is a cutaway view of the electric motor portion of the reactor coolant pump of FIG. 2.

FIG. 37 illustrates the head cap of the motor of FIG. 36.

FIG. 38 depicts the housing of FIG. 37 with stator removed.

FIG. 39 depicts a groove for collecting coolant in the housing of FIGS. 37 and 38.

FIGS. 40 and 41 is a cutaway of the reactor coolant pump motor depicting the upper (rear) bearing in a startup and normal running configuration, respectively.

FIG. 42 illustrates the rotor of the reactor coolant pump bearing embodiment shown in FIGS. 33-41.

FIG. 43 illustrates an alternative embodiment of the bearings of the reactor coolant pumps having a hydraulic thrust bearing.

FIG. 44 illustrates the cap of hydraulic thrust bearing embodiment of the reactor coolant pumps.

FIG. 45 illustrates the hydraulic thrust bearing of FIGS. 43 and 44.

FIG. 46 illustrates the rotor of the embodiment of the reactor coolant pumps shown if FIGS. 43-45.

FIG. 47 shows a perspective view of the lower bearing of the embodiment of the reactor coolant pump shown in FIGS. 43-46.

FIGS. 48 and 49 depict the lower bearing of FIG. 47 in a startup and normal configuration, respectively.

FIG. 50 shows the arrangement of the upper pump housing.

FIGS. 51 and 52 show the rear hydraulic and mechanical radial bearings in the startup and operating configurations, respectively.

### DETAILED DESCRIPTION OF THE PREFERRED EMBODIMENTS

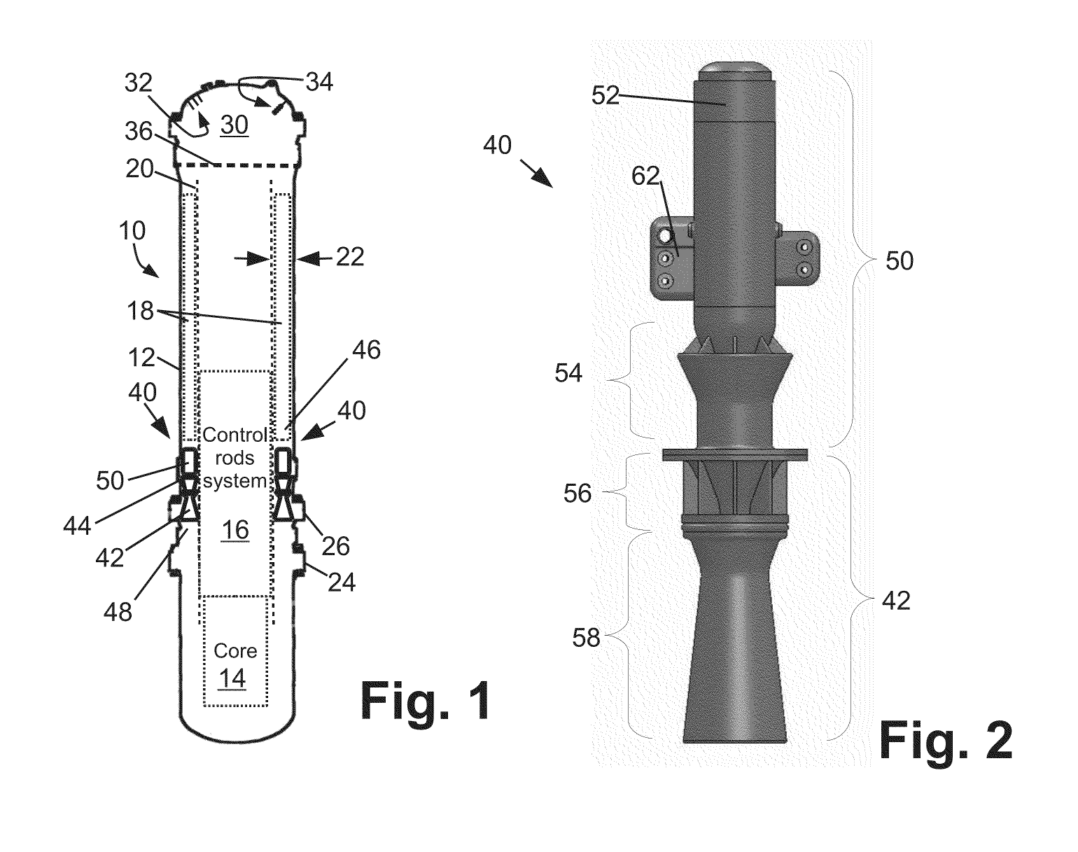

With reference to FIG. 1, an illustrative nuclear reactor of the pressurized water reactor (PWR) type 10 includes a pressure vessel 12, which in the illustrative embodiment is a cylindrical vertically mounted vessel. As used herein, the phrase “cylindrical pressure vessel” or similar phraseology indicates that the pressure vessel has a generally cylindrical shape, but may in some embodiments deviate from a mathematically perfect cylinder. For example, the illustrative cylindrical pressure vessel 12 has a circular cross-section of varying diameter along the length of the cylinder, and has rounded ends, and includes various vessel penetrations, vessel section flange connections, and so forth. Similarly, although the pressure vessel 12 is upright, it is contemplated for this upright position to deviate from exact vertical orientation of the cylinder axis. For example, if the PWR is disposed in a maritime vessel then it may be upright but with some tilt, which may vary with time, due to movement of the maritime vessel on or beneath the water.

Selected components of the PWR that are internal to the pressure vessel 12 are shown diagrammatically in phantom (that is, by dotted lines). A nuclear reactor core 14 is disposed in a lower portion of the pressure vessel 12. The reactor core 14 includes a mass of fissile material, such as a material containing uranium oxide (UO₂) that is enriched in the fissile ²³⁵U isotope, in a suitable matrix material. In a typical configuration, the fissile material is arranged as “fuel rods” arranged in a core basket. The pressure vessel 12 contains primary coolant water (typically light water, that is, H₂O, although heavy water, that is, D₂O, is also contemplated) in a subcooled state.

A control rods system 16 is mounted above the reactor core 14 and includes control rod drive mechanism (CRDM) units and control rod guide structures configured to precisely and controllably insert or withdraw control rods into or out of the reactor core 14. The illustrative control rods system 16 employs internal CRDM units that are disposed inside the pressure vessel 12. Some illustrative examples of suitable internal CRDM designs include: Stambaugh et al., “Control Rod Drive Mechanism for Nuclear Reactor”, U.S. Pub. No. 2010/0316177 A1 published Dec. 16, 2010 which is incorporated herein by reference in its entirety; and Stambaugh et al., “Control Rod Drive Mechanism for Nuclear Reactor”, Intl Pub. WO 2010/144563 A1 published Dec. 16, 2010 which is incorporated herein by reference in its entirety. In general, the control rods contain neutron absorbing material, and reactivity is increased by withdrawing the control rods or decreased by inserting the control rods. So-called “gray” control rods are continuously adjustable to provide incremental adjustments of the reactivity. So-called “shutdown” control rods are designed to be inserted as quickly as feasible into the reactor core to shut down the nuclear reaction in the event of an emergency. Various hybrid control rod designs are also known. For example, a gray rod may include a mechanism for releasing the control rod in an emergency so that it falls into the reactor core 14 thus implementing a shutdown rod functionality. Internal CRDM designs have advantages in terms of compactness and reduction in mechanical penetrations of the pressure vessel 12; however, it is also contemplated to employ a control rods system including external CRDM located outside of (e.g., above) the pressure vessel and operatively connected with the control rods by connecting rods that pass through suitable mechanical penetrations into the pressure vessel.

The illustrative PWR 10 is an integral PWR, and includes an internal steam generator (or set of internal steam generators) 18 disposed inside the pressure vessel 12. In the illustrative configuration, a central riser 20 is a cylindrical element disposed coaxially inside the cylindrical pressure vessel 12. (Again, the term “cylindrical” is “cylindrical” is intended to encompass generally cylindrical risers that deviate from a perfect cylinder by variations in diameter along the cylinder axis, inclusion of selected openings, or so forth). The riser 20 surrounds the control rods system 16 and extends upward, such that primary coolant water heated by the operating nuclear reactor core 14 rises upward through the central riser 20 toward the top of the pressure vessel, where it discharges, reverses flow direction and flows downward through an outer annulus defined between the central riser 20 and the cylindrical wall of the pressure vessel 12. The illustrative steam generator 18 is an annular steam generator (or annular set of steam generators) disposed in a downcomer annulus 22 defined between the central riser 20 and the wall of the pressure vessel 12. The steam generator 18 provides independent but proximate flow paths for downwardly flowing primary coolant and upwardly flowing secondary coolant. The secondary coolant enters at a feedwater inlet 24, flows upward through the steam generator 18 where it is heated by the proximate downwardly flowing primary coolant to be converted to steam, and the steam discharges at a steam outlet 26.

FIG. 1 does not illustrate the detailed structure of the steam generator 18 or the secondary coolant flow path. For example, feedwater inlet tubes and/or a feedwater plenum convey feedwater from the inlet 24 to the bottom of the steam generator 18, and steam outlet tubes and/or a steam plenum convey steam from the top of the steam generator 18 to the steam outlet 26. Typically, the steam generator comprises steam generator tubes and a surrounding volume (or “shell”) containing the tubes, thus providing two proximate flow paths that are in fluid isolation from each other. In some embodiments, the primary coolant flows downward through the steam generator tubes (that is, “tube-side”) while the secondary coolant flows upward through the surrounding volume (that is, “shell-side”). In other embodiments, the primary coolant flows downward through the surrounding volume (shell-side) while the secondary coolant flows upward through the steam generator tubes (tube-side). In either configuration, the steam generator tubes can have various geometries, such as vertical straight tubes (sometimes referred to as a straight-tube once-through steam generator or “OTSG”), helical tubes encircling the central riser 20 (some embodiments of which are described, by way of illustrative example, in Thome et al., “Integral Helical Coil Pressurized Water Nuclear Reactor”, U.S. Pub. No. 2010/0316181 A1 published Dec. 16, 2010 which is incorporated herein by reference in its entirety), or so forth.

The pressure vessel 12 defines a sealed volume that, when the PWR is operational, contains primary coolant water in a subcooled state. Toward this end, the PWR includes an internal pressurizer volume 30 disposed at the top of the pressure vessel 12 containing a steam bubble whose pressure controls the pressure of the primary coolant water in the pressure vessel 12. The pressure is controlled by suitable devices such as a heater 32 (e.g., one or more resistive heaters) that heats the steam to increase pressure, and/or a sparger 34 that injects cool water or steam into the steam bubble to reduce pressure. A baffle plate 36 separates the internal pressurizer volume 30 from the remainder of the sealed volume of the pressure vessel 10. By way of illustrative example, in some embodiments the primary coolant pressure in the sealed volume of the pressure vessel 12 is at a pressure of about 2000 psia and at a temperature of about 300° C. (cold leg just prior to flowing into the reactor core 14) to 320° C. (hot leg just after discharge from the reactor core 14). These are merely illustrative subcooled conditions, and a diverse range of other operating pressures and temperatures are also contemplated. Moreover, the illustrative internal pressurizer can be replaced by an external pressurizer connected with the pressure vessel by suitable piping or other fluid connections.

A set of reactor coolant pumps (RCPs) 40 is configured to drive circulation of primary coolant water in the pressure vessel 12. Each RCP 40 comprises one or more jet pumps 42 disposed in the pressure vessel 12. The jet pumps are mounted on an annular pump plate 44 that separates the suction side 46 of the RCP 40 from the discharge side 48 of the RCP 40. The jet pumps 42 employ primary coolant water accelerated by one or more electrically driven hydraulic pumps 50 as the motive fluid that is accelerated to create a low pressure region that draws additional primary coolant through a suction inlet into the jet pump 42. The electric motors of the hydraulic pumps 50 are mounted internally to the pressure vessel 12, minimizing the number of vessel penetrations that could lead to a loss of coolant accident (LOCA). Placing the electrical pumps in the pressure vessel 12 creates design challenges due to the difficult environment inside the pressure vessel 12, such as high temperatures. The motors of the hydraulic pumps 50 may be a canned motor pump because such pumps are more easily insulated, though other types of motors are contemplated.

With reference to FIG. 2, an RCP 40 with a canned motor hydraulic pump 50 is shown connected to a jet pump 42. In the illustrative example, the hydraulic pump 50 includes a glandless canned pump motor 52 having a generally vertical orientation and an impeller housing 54 attached to the motor housing. The jet pump 42 includes a suction inlet 56 and lower transition/diffuser section 58. The hydraulic pump housing is connected to an electrical and coolant connector 62.

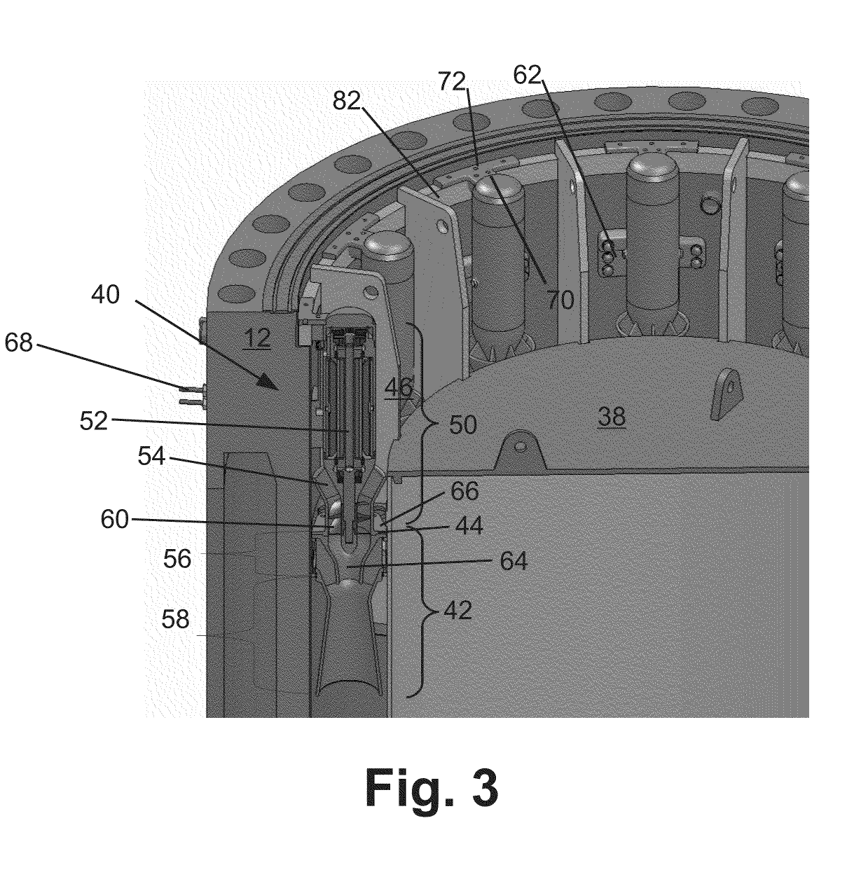

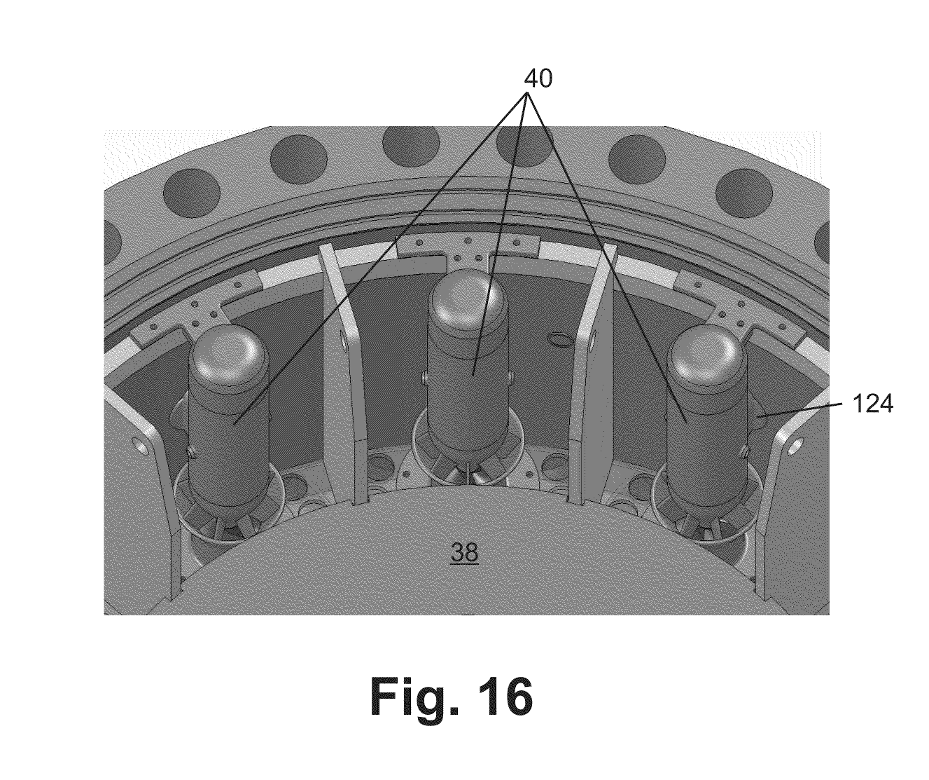

FIG. 3 is a cut-away perspective view of a portion of the pressure vessel 12, and includes a cutaway of one illustrative reactor coolant pump 40 including hydraulic pump 50 and jet pump 42 located within the downcomer annulus 22. In FIG. 3, the reactor shroud has been removed and a maintenance cover plate 38 installed. In cut-away, impeller 60 is visible within the impeller housing 54. The interior of the impeller housing 54 is also visible. The housing 54 is conical with a flange 66 which attaches to pump plate 44. The housing 54 has fixed vanes 55 (see FIG. 16) and creates an annular inlet to the impellor 60, forming the suction side of the impeller 60. The hydraulic pump 50 itself is on the suction side 46 of the jet pump 42.

The jet pump 42 includes a suction inlet 56 and diffuser section 58. In cut-away, the inlet nozzle 64 to the jet pump is visible within the suction inlet 56. The impeller 60 pumps primary coolant to the inlet nozzle 64 of the jet pump 42. The space between the inside of the impeller housing 54 and the motor body 52 creates the annular opening to the impellor 60, which in turn feeds the jet pump nozzle 64.

With continuing reference to FIG. 3, the entire reactor coolant pump 40, including motor 52 and impeller 60, is internal to the pressure vessel to minimize the amount of external piping, thus reducing the possibility of a small break loss-of-coolant accident (LOCA). Penetrations 68 are provided to supply electrical power to the electric motor 52. A small coolant line (not shown) may also be included to provide the pump motor with cooling. A top bracket 70 connects the pump motor 52 with the upper shroud support ring 82 via bolt holes 72.

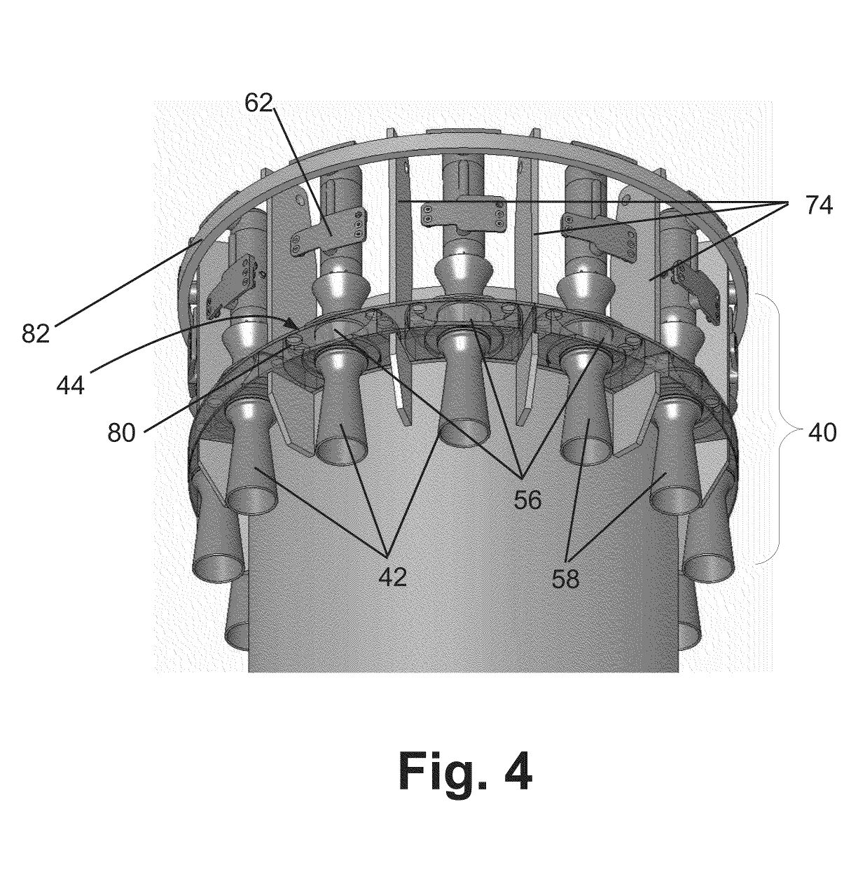

FIG. 4 is a detail of the pump plate 44 with the reactor vessel 12 not shown. Pump plate 44 is mounted above and forms part of a circumferential manifold box 80 in the upper portion of the central riser 20 (which defines the innermost extent of the downcomer annulus) with the pump plate 44 forming an annular element (or annular assembly of constituent arcuate elements) supporting the reactor coolant pumps (one of which is labeled 40 in FIG. 4). The manifold box 80 forms a flow distribution plenum which is in fluid communication with the suction inlets (three of which are labeled 56) of the jet pumps (three of which are labeled 42).

Computational fluid dynamics (CFD) simulations have been used to investigate an approach of inserting many relatively smaller and more compact jet pumps on a manifold box, with trade-offs between a longer transition zone from the nozzle tip to the start of the diffuser, diffuser angle, and jet pump size. Making the jet pump too large can lead to difficulty mounting the pump due to opening size and required support structure for weight. Additionally, in previous boiling water reactor (BWR) designs, durability of long diffusers has been a concern.

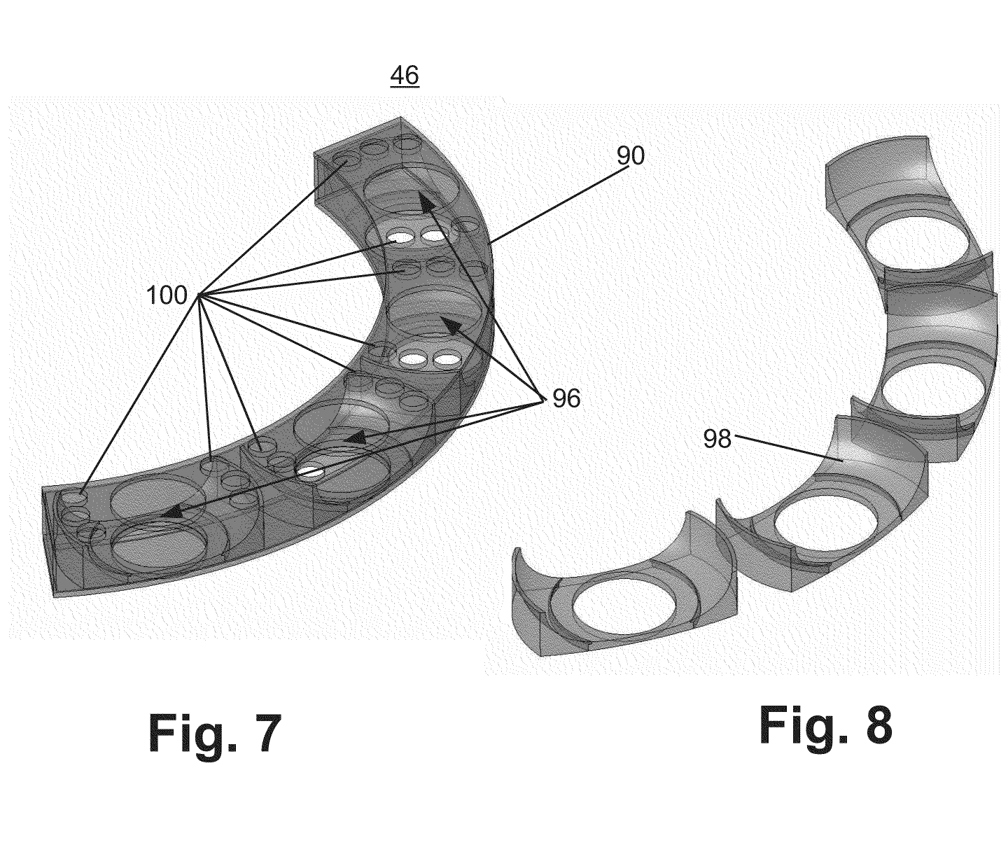

Continuing with FIG. 4, the manifold box 80 is mounted to the upper reactor shroud support ring 82 and, in the illustrated embodiment, supports twelve reactor coolant pumps 40 (embodiment having less or more RCPs are also contemplated). The reactor coolant pumps 40 are removable from the top individually or the entire assembly (shroud support ring 82 and manifold box 80) can be removed. The entire assembly would normally only be removed for inspection of the reactor vessel at intervals longer than the refueling cycle. Alternately, several reactor coolant pumps 40 can be removed from their openings in the manifold box and the reactor vessel inspected remotely using the openings for inspection probes. The manifold box may be comprised of segments which are mounted in between the gussets 74 of the reactor upper shroud, as discussed with respect to FIG. 7, allowing the manifold box and shroud ring to be inserted as a unitary assembly without damage to the manifold boxes. The tapered ends of the gussets 74 guide the assembly into the reactor vessel.

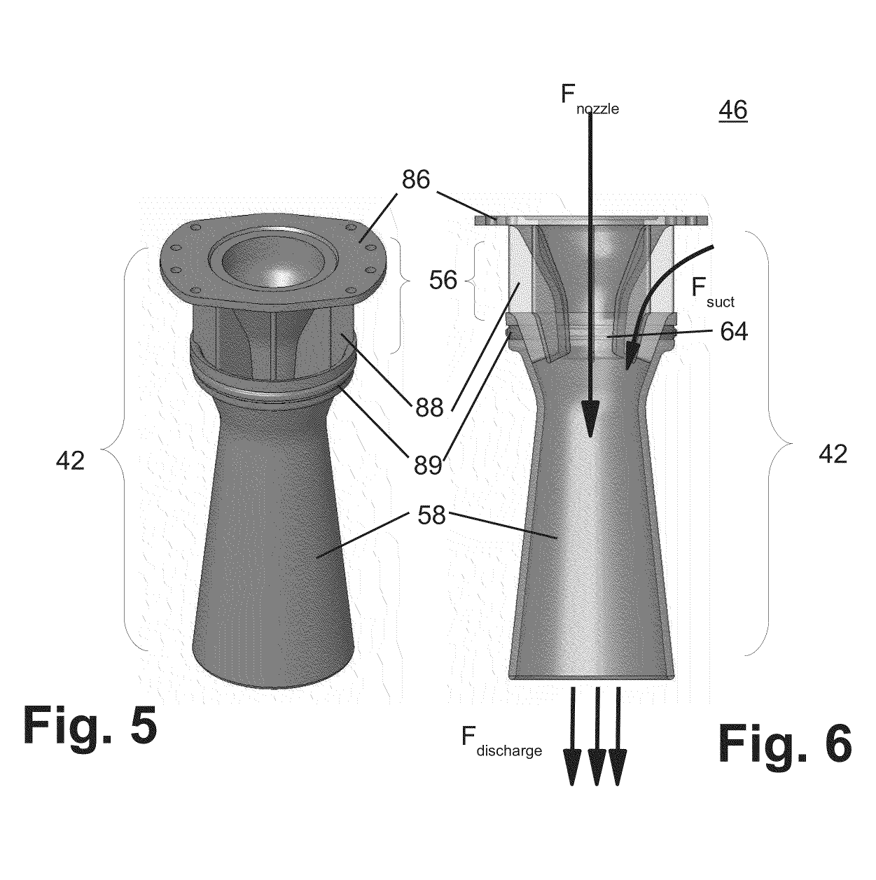

FIGS. 5 and 6 are details of the jet pump 42. FIG. 5 depicts a perspective view of the exterior of the jet pump. FIG. 6 shows the jet pump in cut-away with vanes 88 in phantom. The jet pump 42 has a mounting flange 86 that connects with a top of the manifold box. Below the mounting flange 86 is an annular open space forming the suction inlet 56 to the jet pump 42. The suction inlet 56 takes suction from the manifold box 80 and has fixed vanes 88 spanning the space between the flange and the lower transition/diffuser cone section 58. Below the fixed vanes 88 but above the diffuser is a compression ring 89. The mounting flange 88 mounts on top of and seals to the top of the flow distribution plenum 80 and the compression ring 89 seals to the bottom of the flow distribution plenum. The nozzle 64 is in the center of the annular gap defined by the suction inlet 56 of the jet pump 42. The exterior of the nozzle 64 is attached to the fixed vanes 88. The internal pumps and jet pumps are constructed with modular parts so they can be removed for replacement. The fixed vanes 88 provide the only structural connection between the inlet nozzle with mounting flange 86 and the lower transition/diffuser section 58. All of the jet pump components are contained in a single removable module. This facilitates maintenance as compared with conventional BWR jet pumps, as erosion, fouling, and wear can be easily remediated by replacing the entire module during reactor refueling. Because the jet pumps have no moving parts, they only need periodic inspection and replacement if structural defects are found. Inspection can be done in parallel with refueling so as to not extend the outage.

The illustrative jet pumps 42 are single-stage jet pumps in that there is only one nozzle 64, though other designs are contemplated (e.g., a two-stage jet pump). The jet pump also includes a diffuser 58 located below the suction inlet 56 and below the pump plate 44 (see FIG. 4). The jet pump nozzle 64 creates a low pressure zone which draws secondary flow from the space around the nozzle. The entrained flow is called the suction flow which combines with the nozzle jet flow to create the flow required by the reactor coolant system (RCS). The internal pump impellors 60 create the nozzle jet flow. The jet pump mass flow ratio is the ratio of the suction flow to the nozzle jet flow. Typical jet pump mass flow ratios are in the range of 0.4 to 0.8. So for a jet pump with mass flow ratio of 0.6, 1/1.6 or 62.5% of the RCS flow is injected by the nozzle.

There is a trade-off between placing the hydraulic pump motor inside the reactor vessel (as in the illustrative embodiments) versus outside the reactor vessel. The velocities through external pumps generally are higher with a correspondingly higher irrecoverable pressure drop. This inefficiency is somewhat offset by the lower pump motor cooling required for pumps located outside the vessel. By comparison, internal pumps (see, e.g., Ketch et al., U.S. Pat. No. 6,813,328) have high heat losses for pump cooling. The internal pump with jet pump disclosed herein (e.g., RCP 40) overcomes both of these limitations. The internal motor directly coupled to the jet pump nozzle eliminates the external pipe pressure drop losses of external pumps. As a canned motor is more effectively insulated, the heat losses can be reduced.

The jet pump provides pump head for the RCS loop by recovering the fluid momentum in a diffuser section 58 at the outlet of the jet pump. The diffuser angle should be small enough to suppress recirculation and irrecoverable losses, but large enough so that the diffuser length is not excessive. The diffuser in one embodiment is an integral part of the lower jet pump module 42. The diffusers length is short enough so the jet pump can be supported by the flange 86 mounted to the pump plate 44 at the top of the manifold box 80, and in one embodiment the diffuser sections are shorter than those of the BWR jet pumps. The flange 86 connected to the manifold box 80 also supports the internal pump motor. This support is augmented with an upper support bracket 70 connected to the shroud support ring 82 (see FIG. 4). In this way, the jet pumps are readily removable for maintenance or replacement.

The jet pump 42 is a single-stage jet pump. With particular reference to FIG. 6, in operation the electrically driven hydraulic pump 50 delivers primary coolant under pressure to the nozzle 64 generating a nozzle flow (F_{nozzle}) flowing through the jet pump 42. The nozzle flow (F_{nozzle}) entrains suction flow (F_{suct}) drawn from the suction side 46 of the jet pump 42 through the suction inlet 56, which draws fluid from the annular flow distribution plenum 80. These primary flows (F_{nozzle}, F_{suct}) mix together inside the diffuser 58 and discharge from the diffuser 58 as jet pump discharge flow (F_{discharge}). The overall effect is to convert the relatively higher pressure but low flow rate nozzle flow (F_{nozzle}) into a relatively lower pressure but higher flow rate discharge flow (F_{discharge}). The jet pump 42 thus operates as a pressure-to-flow transformer. Additionally, turbulent mixing between single-stage jet nozzle flow and suction flow from the manifold box occurs in the diffuser helps to ensure uniform temperatures in the downcomer.

The single-stage jet pump 42 is an illustrative example. An alternate configuration would be to have multiple suction inlets, as disclosed in U.S. patent application Ser. No. 13/863,427. Different hydraulic pump/jet pump ratios can be achieved by having one, two, three, or more nozzles driven by the hydraulic pump. In overall operation, the RCP 40 provides a pressure head to primary coolant flow transformation in which a relatively higher head but lower flow output of the hydraulic pump 50 is converted by the jet pumps 42 to a relatively lower head but higher flow output for circulating the primary coolant in the pressure vessel.

FIG. 7 shows an arcuate pump plate segment 90. An assembly of such pump plate segments (in one embodiment three) suitably forms the complete pump plate 44 (see FIG. 4). The arcuate pump plate segment 90 includes four pump mounting openings 96, each opening passing through the top and the bottom of the segment 90, passing through the segment 90 for mounting four jet pumps 42 (see FIG. 4). In some embodiments, the jet pumps 42 are mounted in a fashion that enables installation and/or removal from one side (the suction side 46 in the illustrative embodiment). Returning momentarily to FIG. 4, the segmented construction of the annular pump plate 44 is convenient if the annulus is interrupted by gussets 74 connecting the support ring 82 with the riser 20. The tapered ends of the gussets 74 guide the pump plate 44 into the reactor vessel. Each pump plate segment 90 defines a compartmentalized portion of the overall annular flow distribution plenum 80. Toward this end, the jet pump 42 includes a mounting flange 86 (see FIGS. 5 and 6) that is secured to the top of the pump plate 44 via suitable fasteners, and a compression ring 89 (see FIG. 6) such as an o-ring or gasket that is compressed between the jet pump 42 and a perimeter of the bottom of mounting opening 96 to seal the mounting opening. To ensure a good seal, the bottom perimeter of the mounting opening 96 against which the compression ring 89 engages may be a separately manufactured and welded element 98 (see FIG. 8). The illustrative element 98 has a dish shape to guide primary coolant flow in the distribution plenum 80 into the suction inlet 56 of the jet pump 42. An inner edge of the element 98 protrudes slightly into the flow distribution plenum 80 to engage the seal ring 89 shown in FIG. 6. In this way, the jet pump 42 is secured to the annular pump plate 44 by fasteners that are accessible from the suction side 46 of the RCP 40 and is not secured to the annular pump plate 44 by any fasteners that are not accessible from the suction side 46. The jet pumps 42 are removable from the top (i.e. suction side 46) individually, or the entire assembly (RCPs 40 including jet pumps 42, central riser 20, and pump plate 44 as shown in FIG. 4) can be removed as an assembled unit.

Returning to FIGS. 7 and 8, the manifold box segment 90 has flow holes 100 to admit coolant into the distribution plenum to supply the suction side of the jet pumps. Flow through the distribution box is created by the suction of the jet pump, as opposed to pressurizing the manifold box by the hydraulic pump. In this embodiment, three flow holes are shown on either side of the pump opening 96 (for a total of six flow holes per pump opening 96), though more or fewer may be used. This provides a flow to the manifold box and ultimately to the suction side of the jet pump, fluidly connecting the suction side of the manifold box to the suction of the jet pump.

The internal pump with jet pump provides a compact flow amplification device that fits in the reactor downcomer annulus between the outer vessel wall and the reactor upper shroud and allows the control rod drive mechanisms 16 to be removed for refueling, without removing the pumps. The jet pump component, which has no moving parts, is separate from the pump motor module.

Placement of the reactor coolant pumps entails providing feedthroughs for electrically connecting and cooling the hydraulic pump motors. The accessibility of the internal pump with jet pump is dependent on the ease of removing the internal electrical and coolant connections. Placing the internal pumps on a mid-flange plate where an upper vessel portion of the pressure vessel 12 separates from a lower vessel portion of the pressure vessel 12 for maintenance allows the pump to be accessible for maintenance. In a suitable configuration, electrical and coolant sockets are provided on and through the mid-flange plate. Two electrical and coolant connection methods are presented below: (1) access from inside the reactor vessel once the steam generator is removed and (2) an alternate side access method.

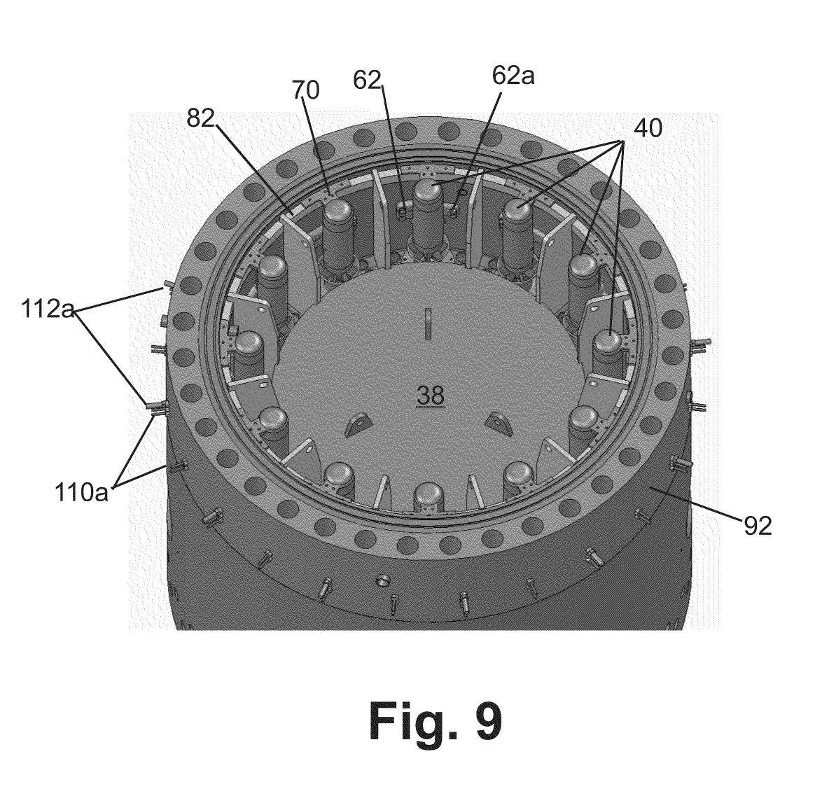

FIG. 9 shows twelve reactor coolant pumps (RCPs) (four of which are labeled 40) positioned in the reactor downcomer annulus 22 (see FIG. 1). This is the same configuration as shown in FIGS. 3 and 4. The entire pump assembly fits within the annular space of the reactor downcomer 22, allowing the control rod drive mechanism 16 to be removed for refueling without removing the pumps 40. In this top access configuration, the coolant and electrical connections 62, 62a are made on the wet side at the access panel on the vessel inner wall, generally with the steam generator removed. A maintenance cover plate 38, shown installed in FIG. 9 (as in FIG. 3), is typically installed when control rod drive mechanism 16 was removed. The reactor coolant pumps 40 are mounted on the mid-flange plate 92. Coolant lines 112 and electrical lines 110 go through the mid-flange plate, and the coolant external connectors 112a and electrical external connectors 110a are visible in FIG. 9.

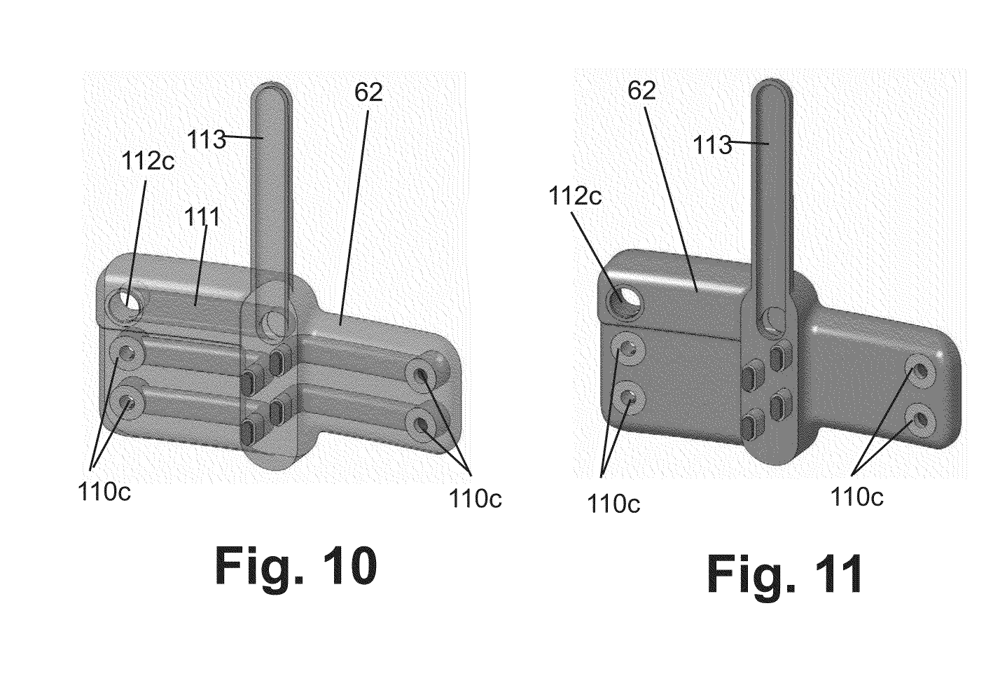

With reference to FIGS. 10 and 11, the access panel 62 is shown. It is curved to fit against the inside surface of the reactor vessel 12 (not shown) and comprises two internal electrical connectors 110c on each side and one coolant line 112c on one side. The coolant internal connector 112c connects via an internal channel 111 (visible in phantom in FIG. 10) to a coolant channel 113 which in turn connects to the pump motor. The illustrated configuration is open loop for the coolant meaning the pump discharges the coolant to the RCS and the normal reactor coolant inventory and purification system (RCIPS) is used for coolant return to the RCIPS heat exchanger. In some embodiments, a closed loop system could be used, requiring a return line from coolant panel and through the reactor vessel wall.

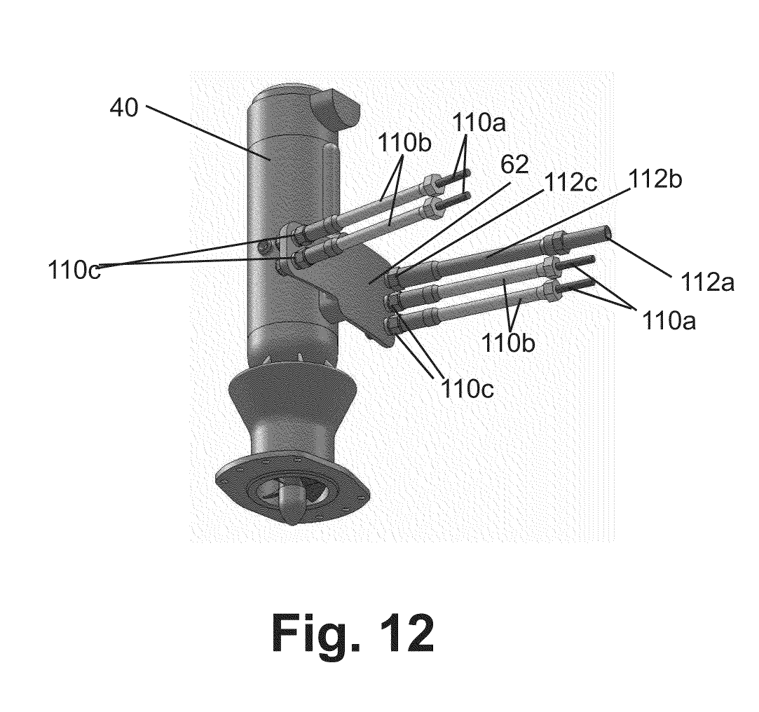

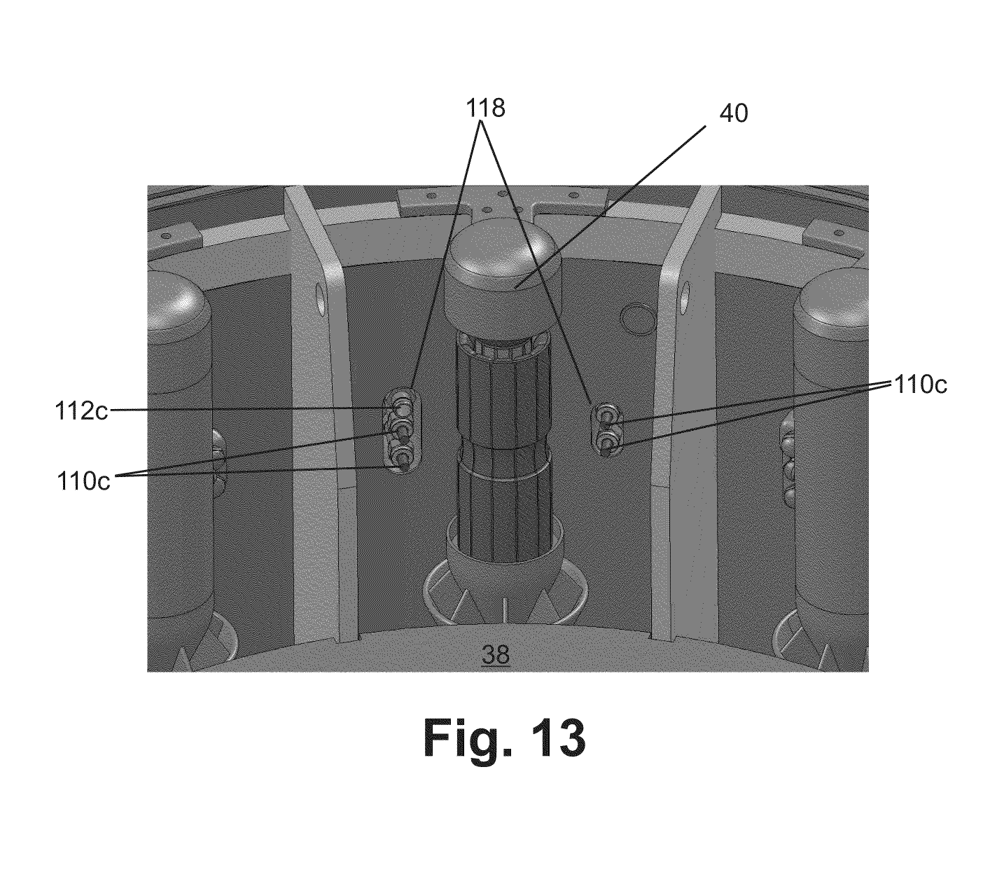

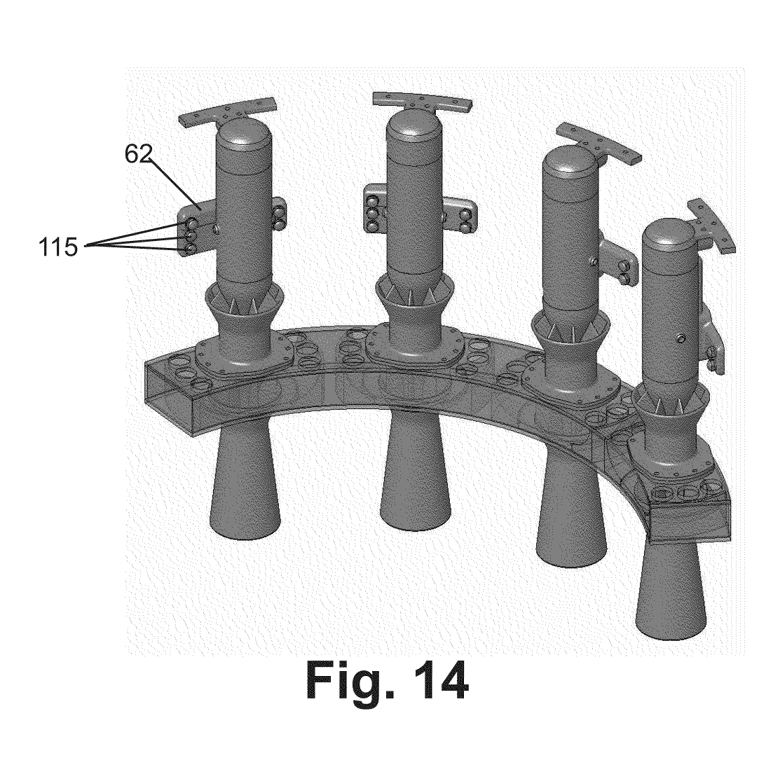

FIG. 12 shows the electrical and cooling panel 62 with the reactor vessel external lines (electrical 110, coolant 112) attached. These lines are long compression fittings that clamp down against matching holes in the vessel. There are extension pieces 110c, 112c on the inner vessel side of the fittings to provide a more accessible means of tightening the hex nuts. One side of the connector 62 includes a single coolant line 112 and two electrical connectors 110 vertically inline. The lines are mounted between two reactor vessel studs, as shown in FIG. 9. On the opposite side of the connector 62 are two more inline electrical connectors 110, which mount between two other studs. These extension pieces are inside cavities 118 milled on the inner wall of the vessel as shown in FIG. 13. Once the compression fittings are sealed against the vessel, the main pump housing can be inserted into the jet pump assembly on the manifold box. The final seal is made with the hex nut caps (three of which are labeled 115 in FIG. 14) mounted on the electrical and cooling panel. The overall arrangement of the top/internal access connection design has minimal obstruction of the flow to the pumps. The hydraulic pump 40 has sealed motor stator windings inside a wet canned motor housing with external cooling.

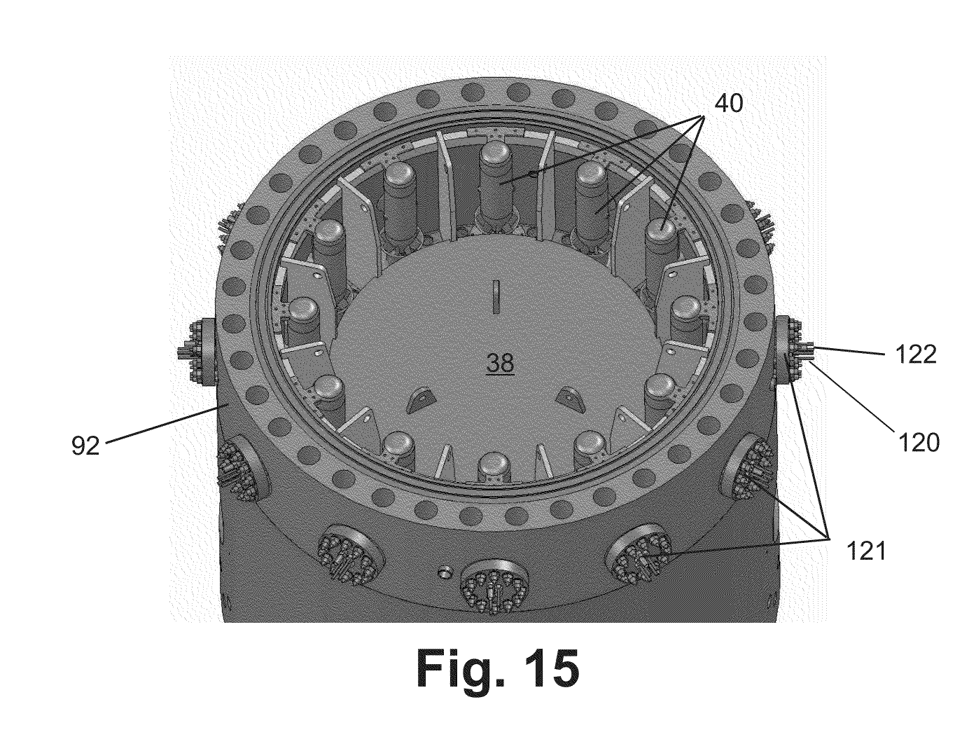

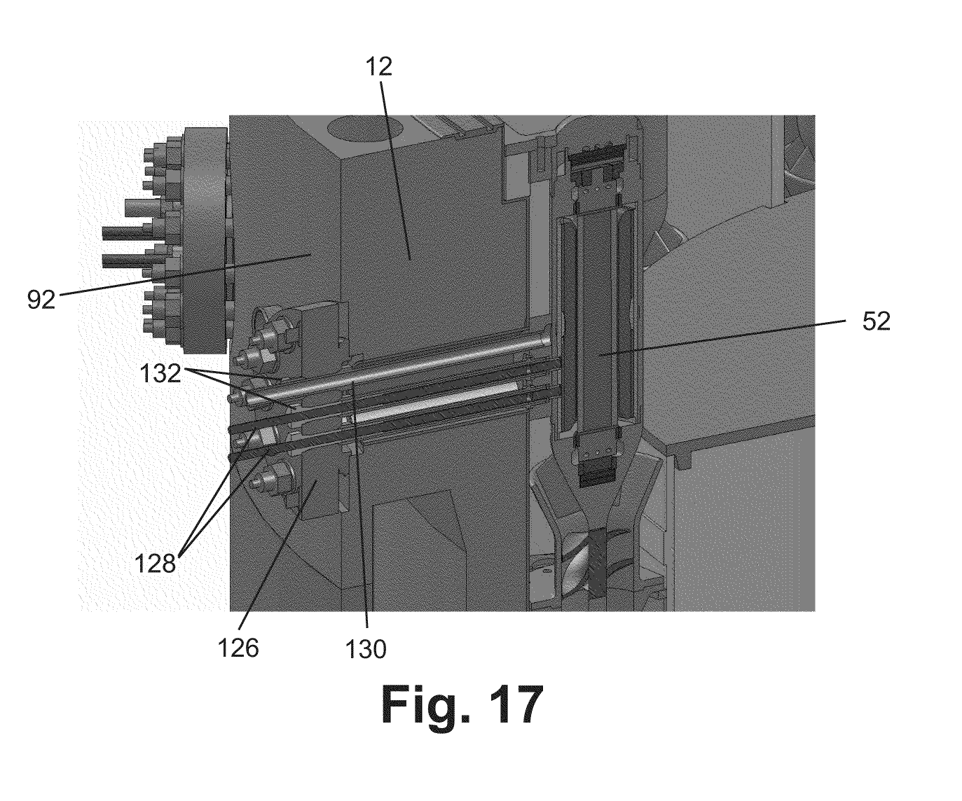

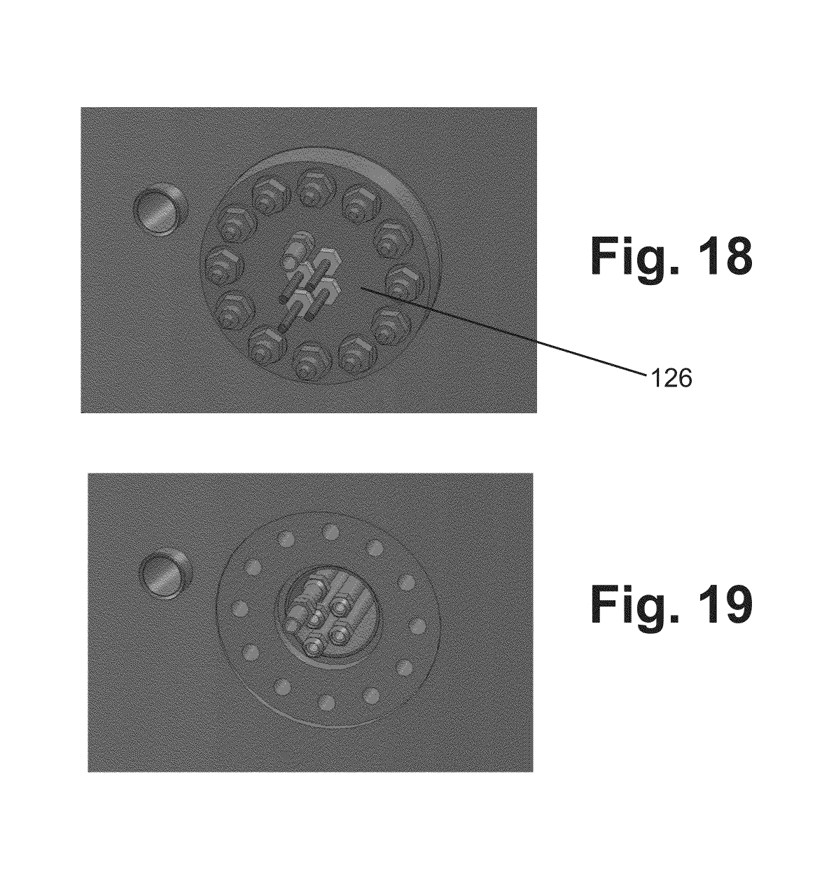

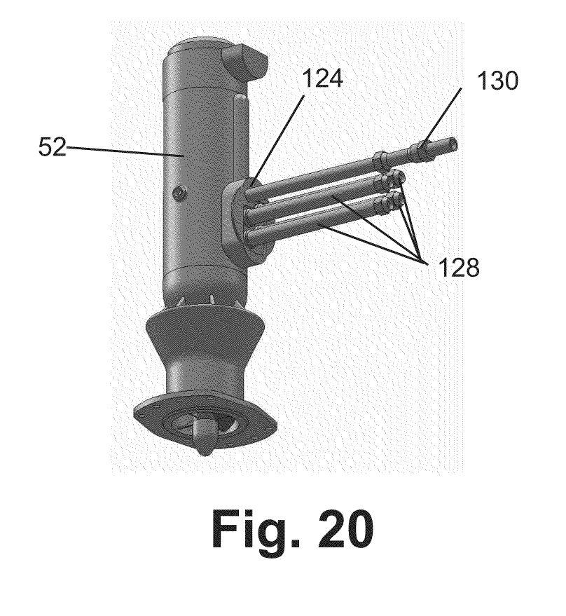

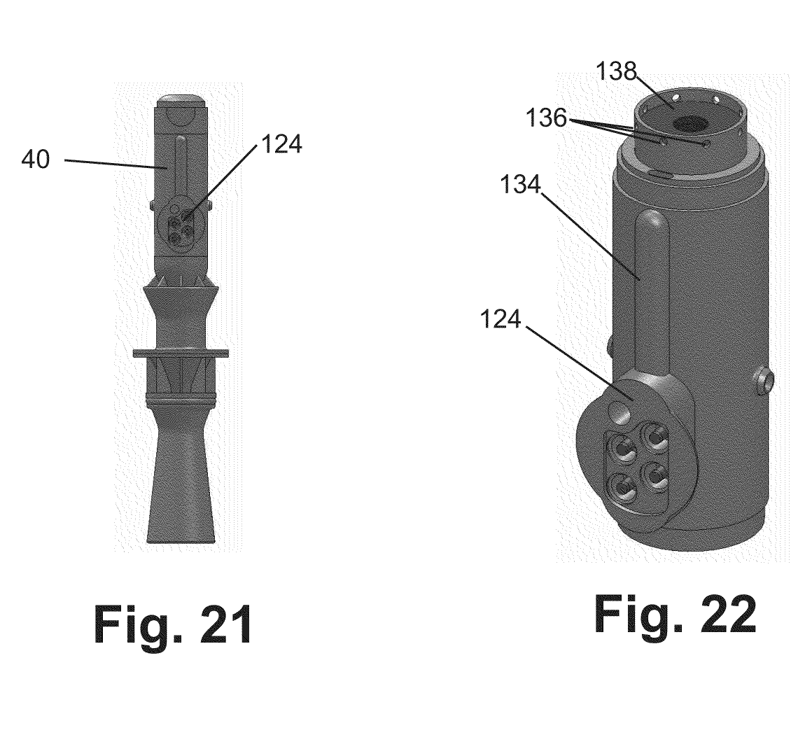

With reference to FIGS. 15-22, an alternate side-access configuration for the electrical and coolant lines is shown in conjunction with twelve RCPs (three of which are labeled 40 in FIG. 15). Electrical covers (three of which are labeled 121) similar to small man-way covers are used around the periphery of the mid-flange 92. In this embodiment, the electrical 120 and coolant 122 connectors are sealed with openings on the covers. In order to remove the pumps 40, the covers are removed and the pumps are disconnected. The pumps can then be removed from the top as in the previous embodiment or, alternatively, the pump motor connections can be serviced and replaced from the access covers without removing the steam generator. The same configuration of circumferential manifold boxes and reactor coolant pumps is used and has the same advantage for removal and inspection of the reactor vessel. FIG. 16 depicts the overall arrangement of the side access reactor coolant pump 40 in the reactor downcomer annulus. The electrical and coolant connectors are inside the vessel wall leaving minimal flow area obstruction. The electrical and coolant line connectors attach to a panel 124 on the motor main housing. The panel covers the holes in the vessel wall for the electrical connectors. FIG. 17 shows a cross-section of electrical lines 128 and coolant lines 130 through the vessel cover 126 connecting to the pump motor 52. The compression fitting extensions used for the vessel side covers are similar to those fittings 114, 116 used for the top access cover plate. The compression fitting seals 132 are external to the vessel 12 on the covers 126. The external view of the side ports with the covers 126 installed is shown in FIG. 18 and removed in FIG. 19. FIG. 20 shows the electrical lines 128 and coolant line 130 attached to the panel 124 on the pump motor housing 52. The side panel 124 of the RCP 40 (in the side access configuration) is shown in FIG. 21 without coolant and electrical lines. A close-up of the electrical and coolant panel socket 124 is shown in FIG. 22 with particular attention to the coolant 134 channel on the pump motor housing. The coolant from the electrical and coolant panel travels vertically upward through the coolant channel to a port hole in the motor housing and through another channel to the top pump motor head. Flow in the annular space in the top head goes through radial holes 136 in the middle housing and across the main thrust bearing 138 for cooling.

In summary, the side access configuration uses a similar reactor coolant pump including jet pump and manifold but a different electrical and coolant connector panel. The side access method allows for maintenance of the connectors without removing the steam generator. Removal of the internal pumps with jet pump requires less exposure time inside the reactor vessel as the connections are made externally.

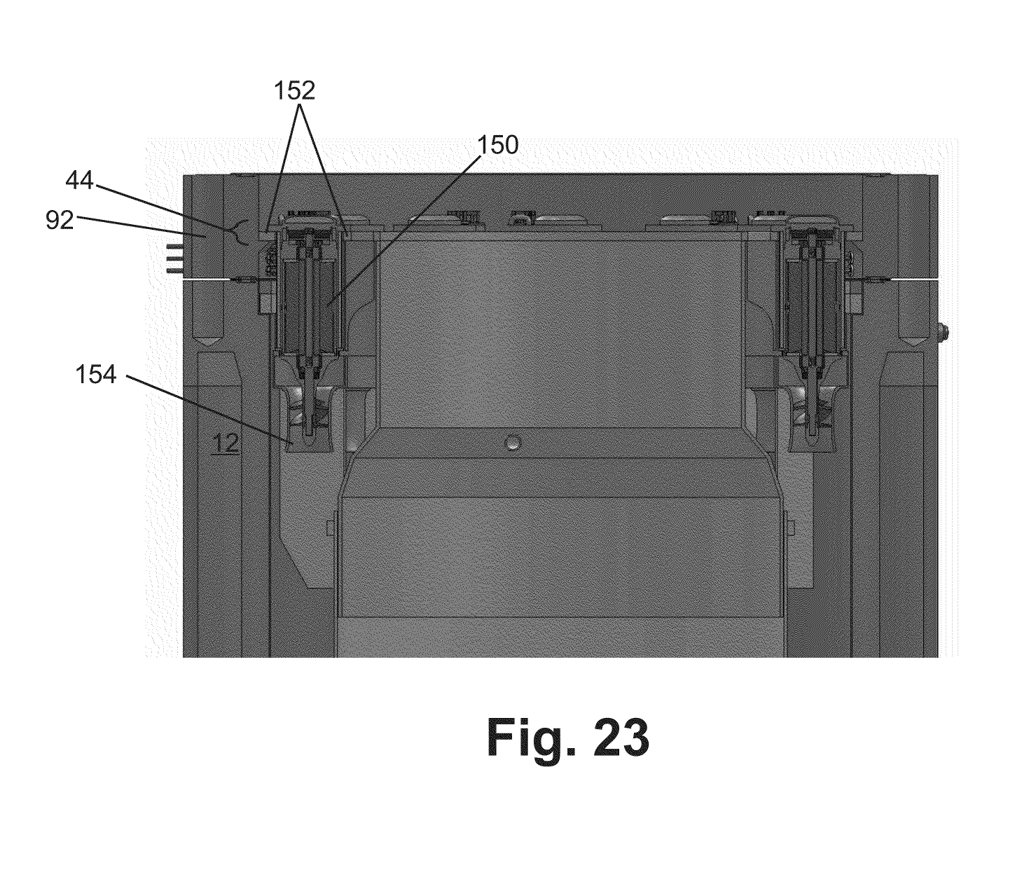

With initial reference to FIG. 23, embodiments are described in which the jet pumps are omitted, and the reactor coolant pump (RCP) includes an internal electrically driven pump that circulates the RCS flow. A cut-away view is shown in FIG. 23. In addition to omitting the jet pumps, the manifold box is also omitted, since there is not a second suction for the jet pump to be fed by the manifold box. Therefore, in this embodiment, the internal electrically driven pump 150 without jet pump is mounted on a pump plate 44 comprised of a plate 152 mounted on the mid-flange 92 of a small modular reactor pressure vessel 12. This plate 152, like the manifold box, creates a sealed boundary between the high and low pressure sides of the RCS. However, the plate 152 has no internal plenum.

As above, the pump motor 150 is an internal canned motor which has the advantage of more effective insulation because RCS flow only passes through the impellor module 154 and not around or through the pump motor 150 as with other designs. Either an open (returning coolant purification to the vessel via the pumps) or closed loop cooling system may be used. The illustrative embodiment is an open system in which there is only one coolant line to each pump and the coolant discharges into the RCS via nozzles on the pump body 150. Return of coolant to the external pump heat exchanger for an open loop system is via the normal pickup line for the Reactor Coolant Inventory and Purification System (RCIPS). Although an open loop concept is less complex, a closed loop coolant system may be advantageous for maximum cooling, as the motor is immersed in RCS water which may be 600 F.

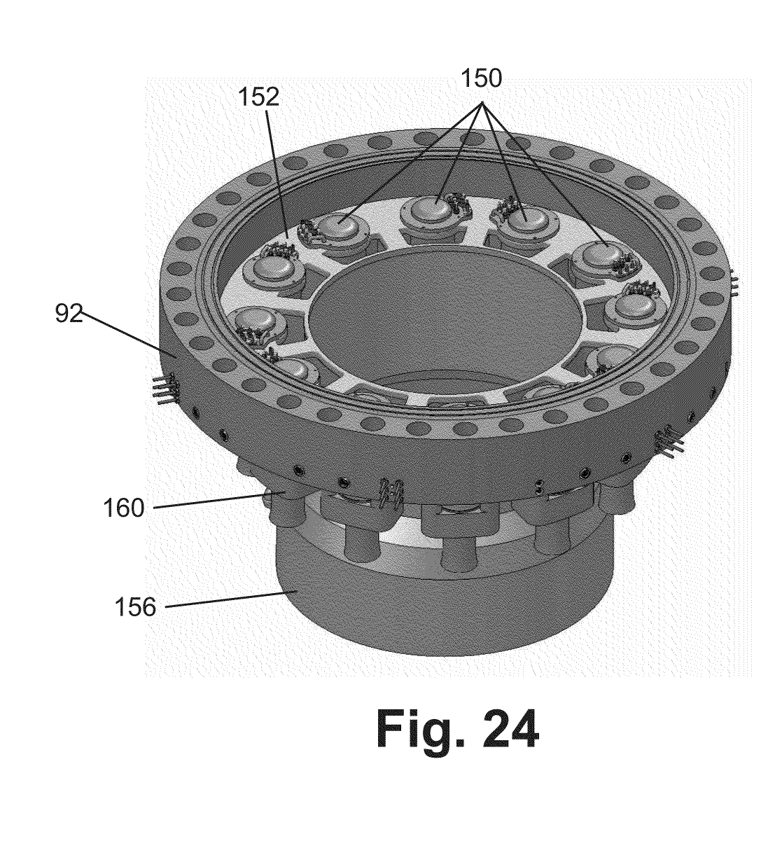

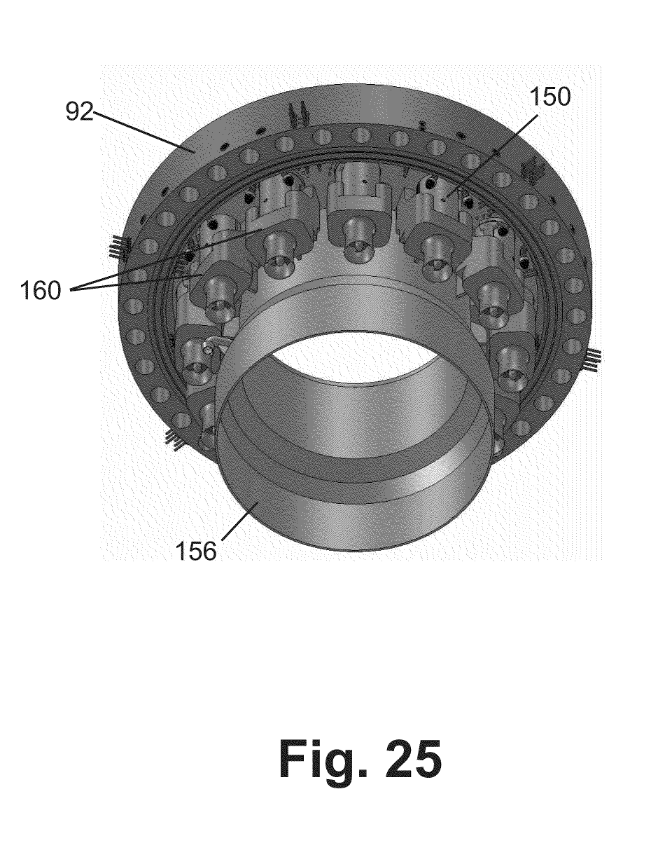

The mid-flange assembly including mid-flange plate 92, pump plate 152, internal pumps 150, and reactor riser transition piece 156 is shown in FIGS. 24 and 25. Each pump 150 is mounted in a flow distributor 160 that is suitably welded to the plate 152 and transition piece 156.

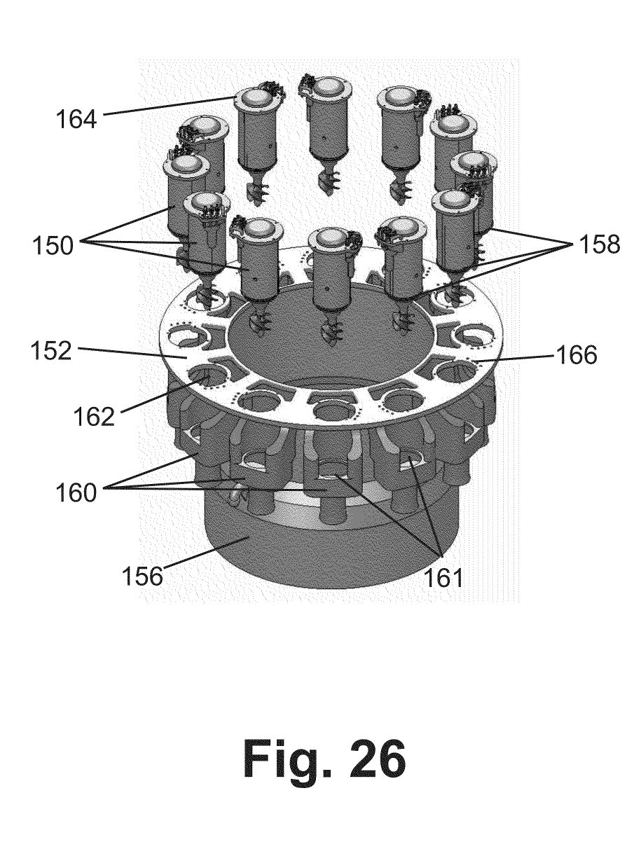

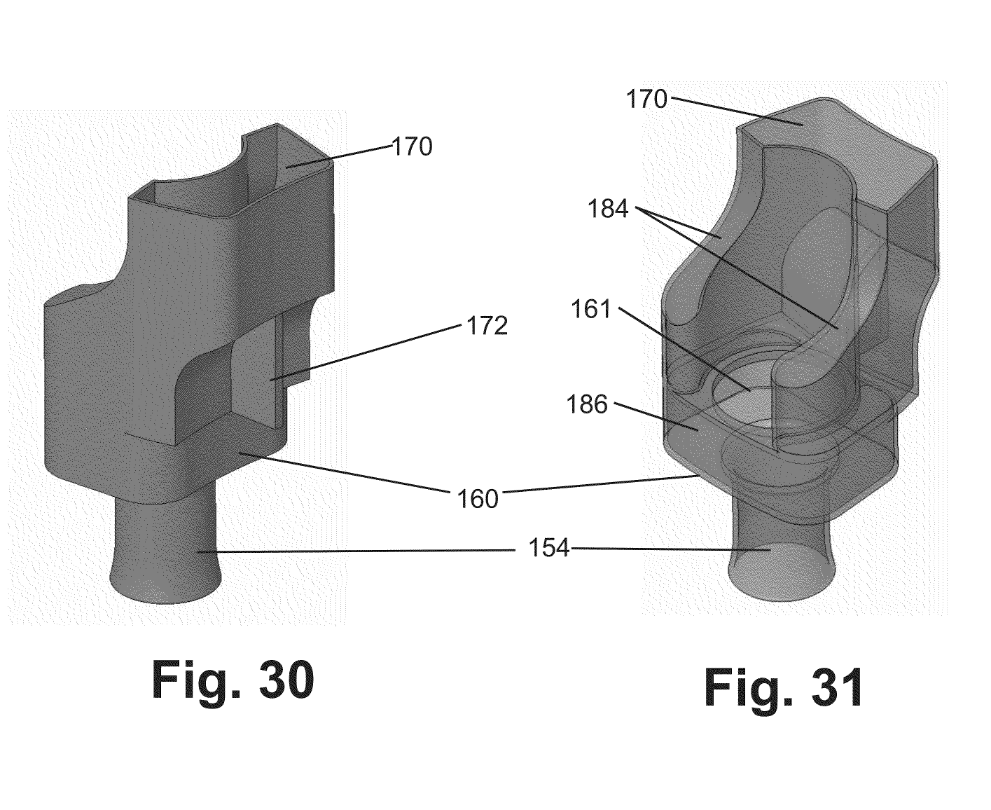

With reference to FIG. 26, holes 162 for the pumps 150 in the mounting plate 152 allow the pumps to be inserted into the flow distributors 160. As shown in FIG. 26 (and FIGS. 24-25), twelve internal pumps 150 are circumferentially positioned on the mid-flange plate 152. Note the openings 162 in the plate for the RCS coolant flow to the internal pumps. There is one dedicated opening for each pump. When the pumps are inserted, a seal is formed between the respective pump's flange (one of which is labeled 164 in FIG. 26) and the pump plate 152 and also between the lower pump compression seal fittings 158 (see also FIG. 29) and the hole 161 in the flow distributor 160 (see also FIG. 31). The electrical and coolant lines are mounted between the reactor studs on the mid-flange and connect to the pumps from below the plate via sockets 166 on the plate. The internal pump motor makes a seal to the hole in the flow distributor with a compression ring.

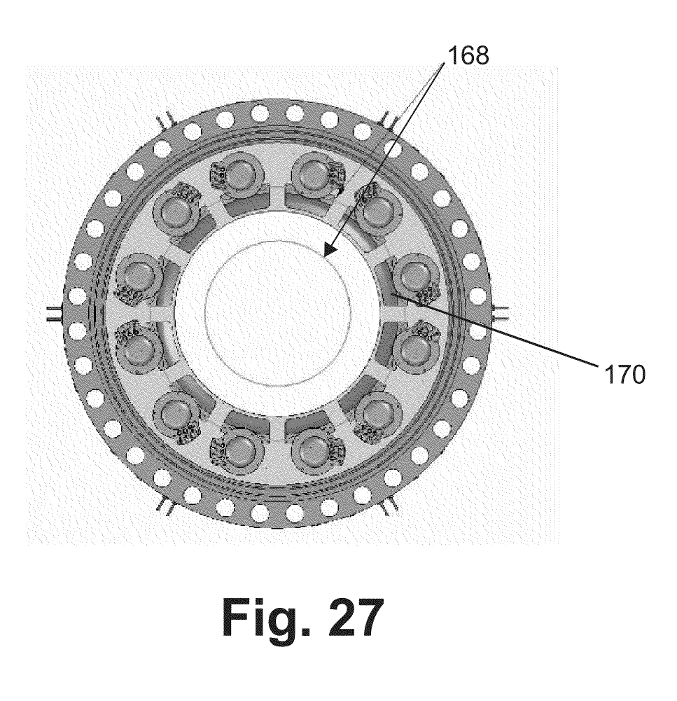

An advantage of the internal pump on the mid-flange is the compatibility of the flow openings with the steam generator above the pumps. With reference to FIG. 27, the extent of the steam generator tube bundle is labeled 168. The inlets 170 to the internal pump span the outer radii of the tube bundle. The flow distribution header inlet is below the outermost span of tubes from the steam generator. The pump outlet is further out in radius to be more in line with the reactor downcomer annulus. A conical transition piece between the pump plate and the steam generator central riser further directs the flow to the pump inlets. This in combination with the outlet of the pumps coinciding with the reactor downcomer annulus makes a good flow transition between the upper and lower vessels of the reactor.

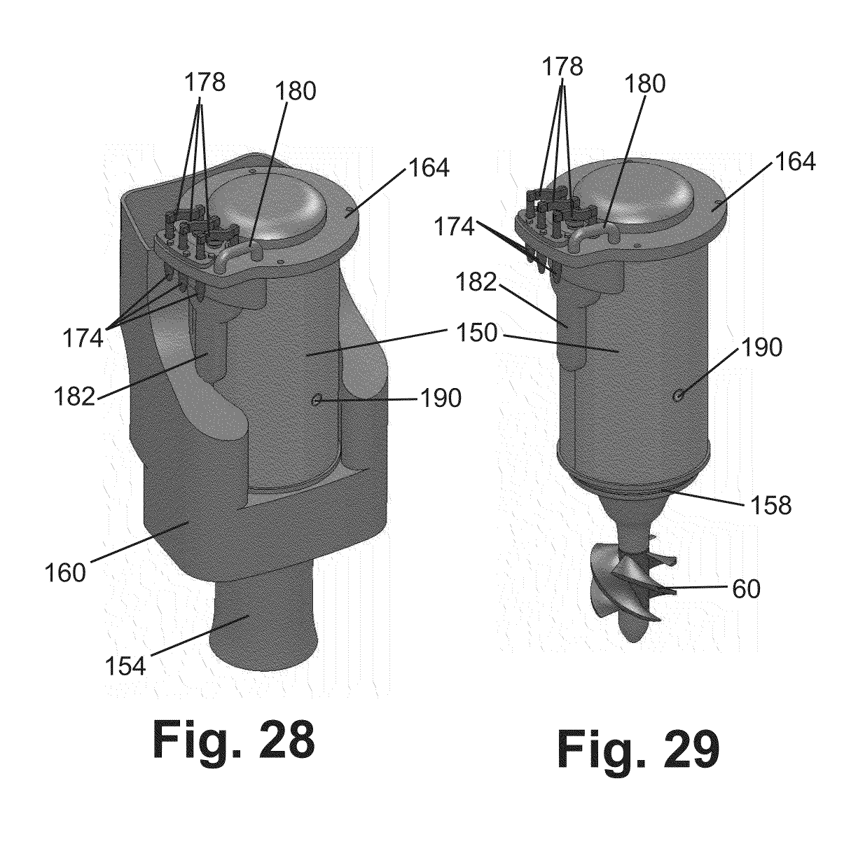

The pump motor 150 seated in flow distributor 160 is shown in FIG. 28, and the pump motor 150 removed from the flow distributor is shown in FIG. 29. The outlet nozzle of the flow distributor 160 forms the outer housing 154 for the pump impellor 60. The shape of the flow distributor is designed to achieve the objective of supplying the pump impellor 60 with coolant symmetrically so as to reduce asymmetrical loads on the pump main shaft radial bearings. The flow distributor 150 resembles an “arm chair,” and the single inlet for the pump, the back, splits between the two “arms” of the flow distributor and enters the pump impellor plenum symmetrically.

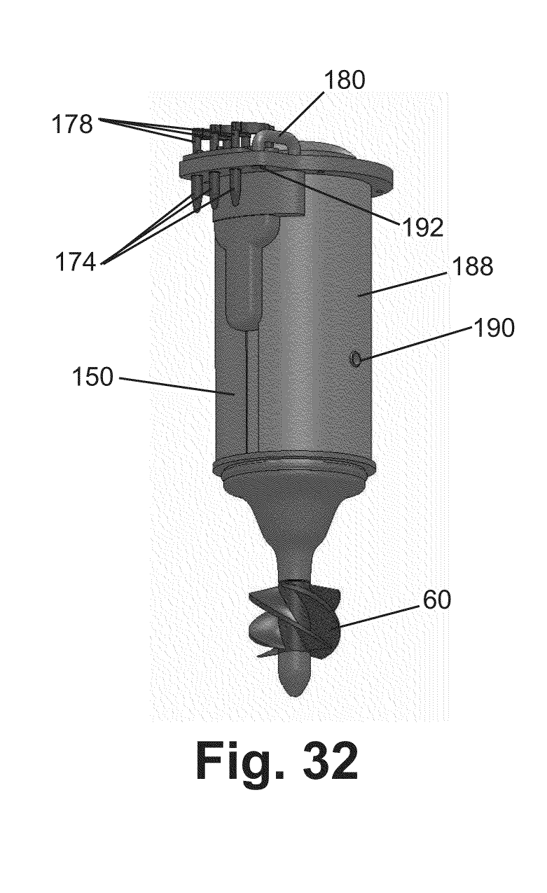

Also visible in FIGS. 28 and 29 are the electrical connections 174 and coolant line 180, located on the pump mounting flange 164, which mate to socket 166 on the pump plate 44 (see FIG. 26). The electrical connections are connected to the pump motor by electrical lines 178. The coolant line 180 on the mounting flange also connects to the main pump body. For a view of the connections from beneath the mounting flange, see also FIG. 32. A coolant channel 182 is visible in FIGS. 28 and 29.

As can be seen in FIG. 30, there is a gusset 172 on the back of the flow distributor 160 which is suitably welded to the riser transition piece 156 (see FIG. 26) for structural support. The flow distributor is shown in phantom in FIG. 31 to reveal the internal geometry and flow path of the distributor 160. The flow path is from the pump inlet 170 to the arms 184 and then to the impellor inlet plenum 186. At the bottom of each arm is an opening into the impellor inlet plenum. The corners of the flow openings inside the flow distributor are optionally rounded over for streamlining. The flow distribution headers take flow from above the mid-flange plate and route the coolant to openings on both sides of the pump impellor. This balances the flow to the pump impellor. The flow distribution header is attached to the mid-flange plate and the upper shroud transition piece to add structural integrity to the entire assembly.

An advantage of the internal pump is ease of insulating the pump motor. FIG. 32 shows the pump motor with the right side outer cover removed to reveal insulation 188 inside the pump motor housing. Note the hole in the insulation for the outlet nozzle 190 of the pump motor coolant. There is also an outlet nozzle on the opposite side of the pump and matching holes in the left and right pump covers (see FIGS. 28 and 29). As mentioned previously, the illustrative pump configuration employs an open loop for the coolant, hence the two outlet nozzles 190 on each side of the pump. Also visible in FIG. 32 is the connection 192 for the coolant line 180. The impeller 60 is also visible.

Because of the high temperatures the pump is exposed to inside the vessel, bearing wear is a significant concern. In one embodiment, the motors of the above embodiments use a heavy-duty mechanical thrust bearing and hydraulic radial bearings for normal operation accompanied by mechanical radial bearings for startup and shutdown. In another embodiment, a hydraulic thrust bearing (accompanied by a startup and shutdown mechanical bearing) replaces the mechanical thrust bearing.

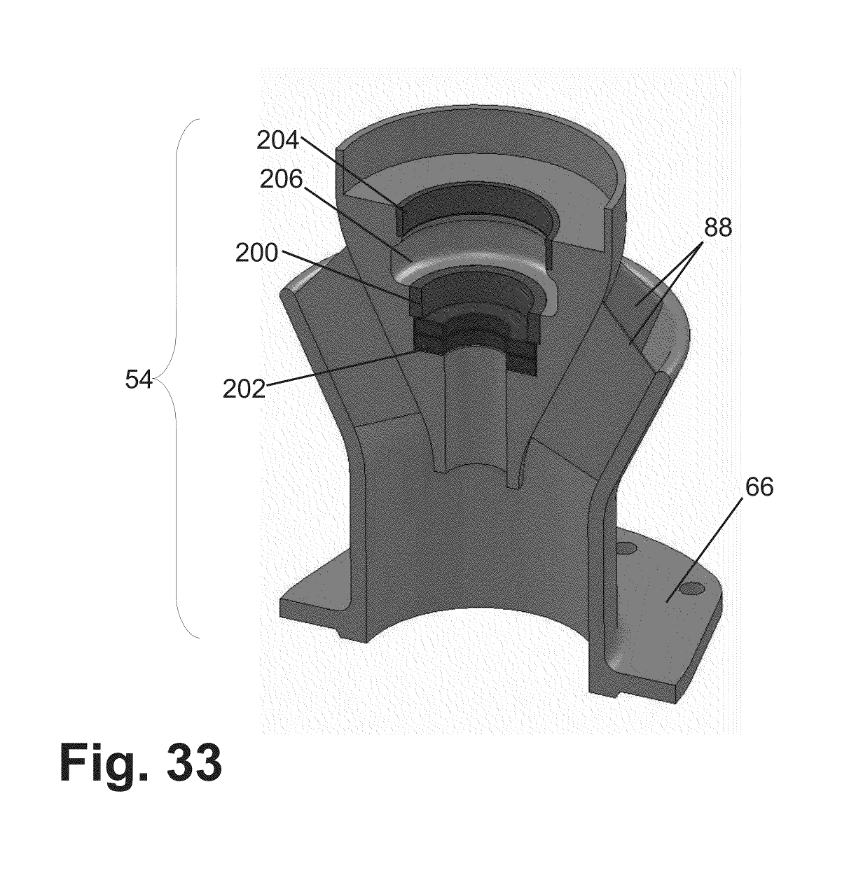

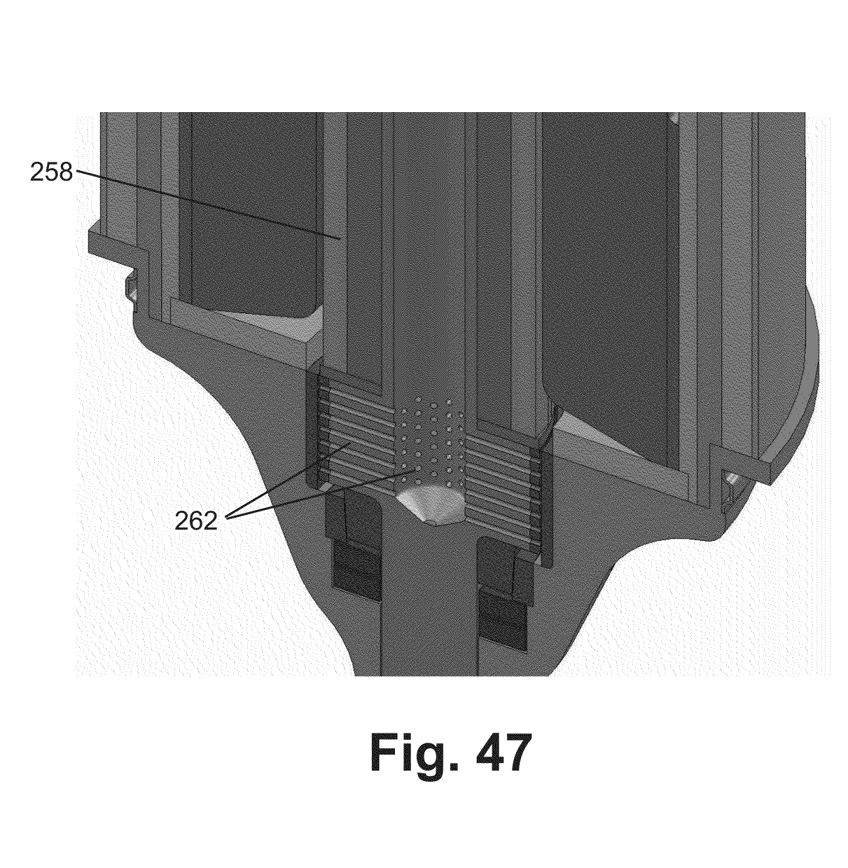

A sectional view of the pump impellor housing 54 is shown in FIG. 33. The impeller housing 54 shown in FIG. 33 is for use with a jet pump. For the housing for use without the jet pump, see FIG. 47. The module 54 connects the pump motor 52 (see FIG. 2) and impellor 60 (see FIG. 3) to the nozzle 64 (see FIG. 3) of the lower jet pump module 42 (see FIG. 2). The impellor housing 54 has a mounting flange 66 that matches the flange 86 on the lower jet pump module 42. Fixed vanes 88 support the portion of the module 54 that contains the lower mechanical radial bearing 200, the thrust startup bearing 202, and the lower hydraulic radial bearing 204. There is also an annular gap 206 between the lower mechanical radial bearing 200 and the hydraulic lower radial bearing 204.

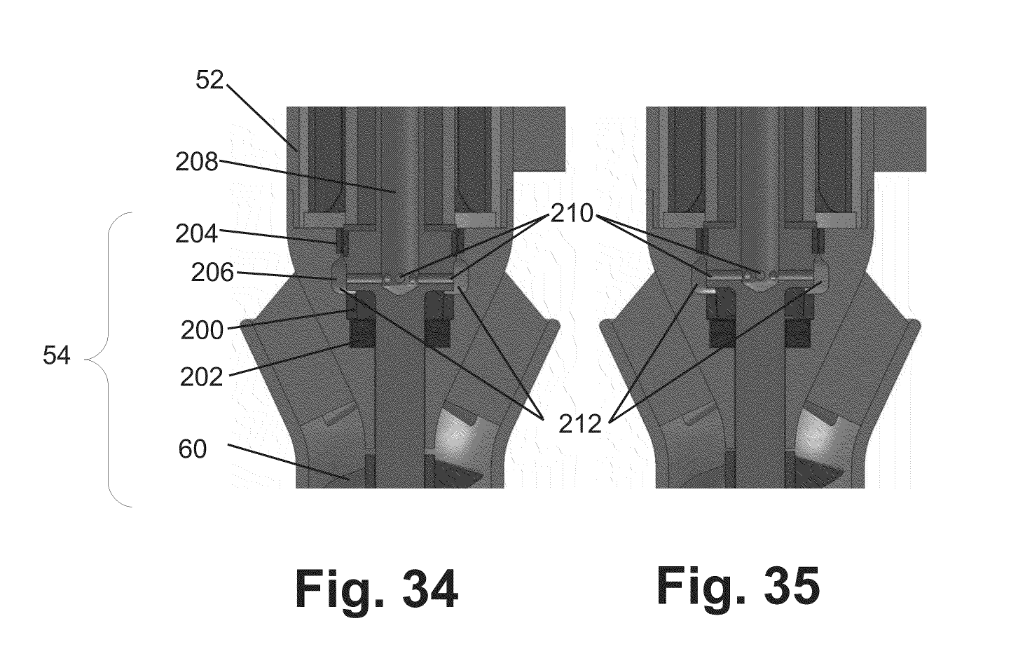

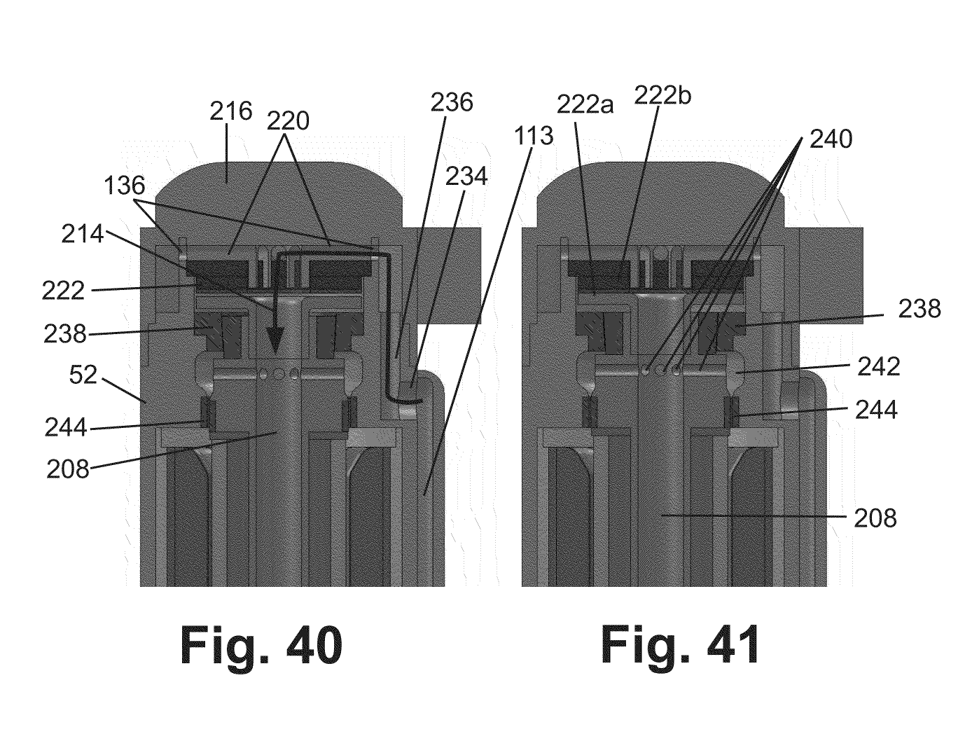

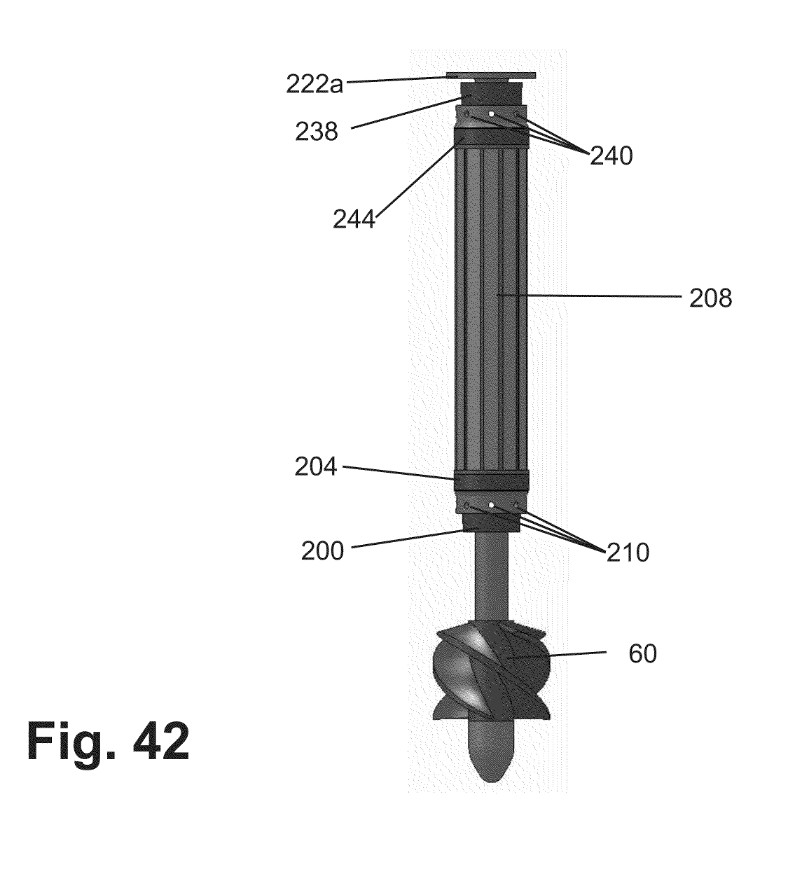

FIGS. 34 and 35 show side-sectional views depicting the front bearing layout during startup (FIG. 34) and during normal operation (FIG. 35). A hollow drive shaft 208 has small holes at both ends to provide coolant to lubricate the radial bearings. Coolant fed from the upper end (upper in the orientation of FIGS. 34 and 35) of the pump motor feeds the shaft (see FIGS. 40 and 42 for the upper bearing layout). The high pressure of the coolant feed forces coolant through radial holes 210 in the drive shaft to an annular plenum 212 formed by the shaft, the annular bearing gap 206 and the impeller housing 54. There are also radial holes in the upper end of the shaft, as will be discussed with respect to FIGS. 40 and 41. Coolant flows from the annular plenum 212 upward and through the gap 206 between the inner and outer surfaces of the hydraulic lower radial bearing 204. The flow across this gap is under high pressure and forms a thin liquid layer which carries the load of the hydraulic radial bearing 204.

The lower mechanical radial bearing 200 uses the (axial) thrust of the drive shaft 208 for engagement and disengagement. The rearward (upward as shown in FIG. 34) pusher thrust of the axial flow impellor 60 causes the drive shaft 208 to slide axially. The main shaft displacement disengages the mechanical radial bearings 200 because it has a tapered (angled) bearing surface. A very small axial displacement, as shown in FIG. 35, of approximately ⅛″ will open the interface of the mechanical radial bearing 200 so that it is not loaded during normal operation. The small axial displacement also disengages the mechanical startup/shutdown thrust bearing 202 on the front. At startup, the inner bushing of the mechanical radial bearing 200 contacts the startup thrust bearing 202. This limits the travel of the main shaft during startup and shutdown. During normal operation, the main shaft is displaced inward (upward with respect to FIGS. 34 and 35) by the impellor thrust, so the startup thrust bearing 202 is disengaged. During normal operation, there is only need for one thrust bearing at the top (rear) of the shaft. Unloading the mechanical bearings gives long service life since the rotational friction force is carried on fluid surfaces.

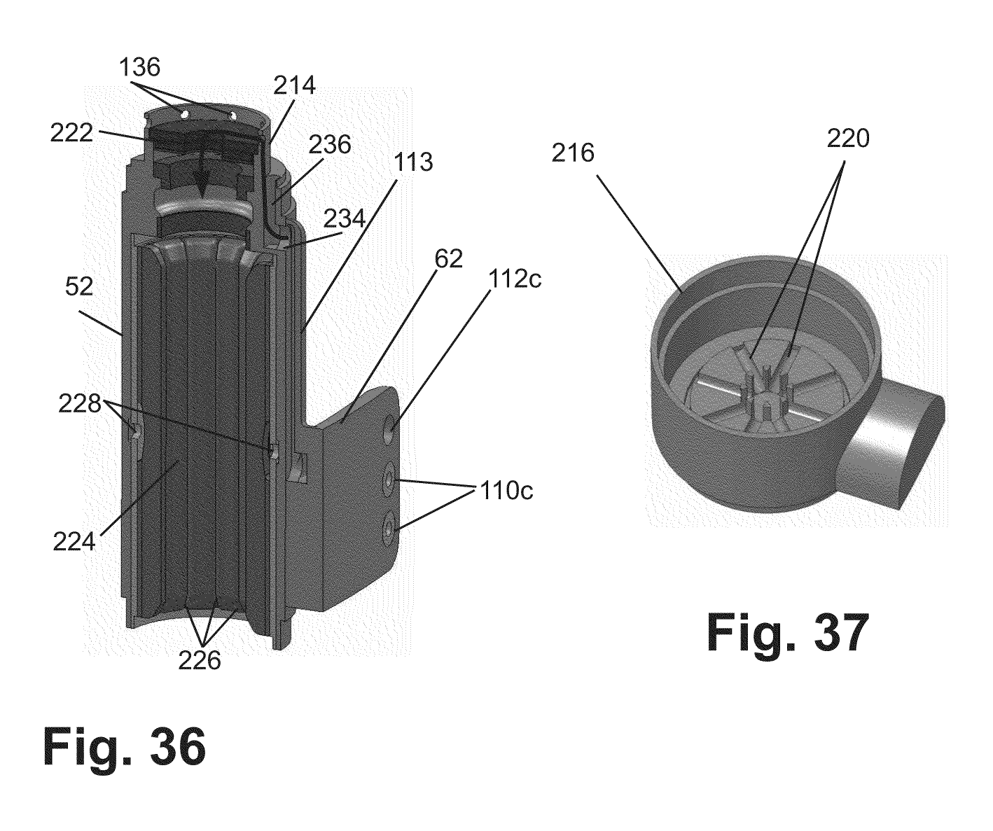

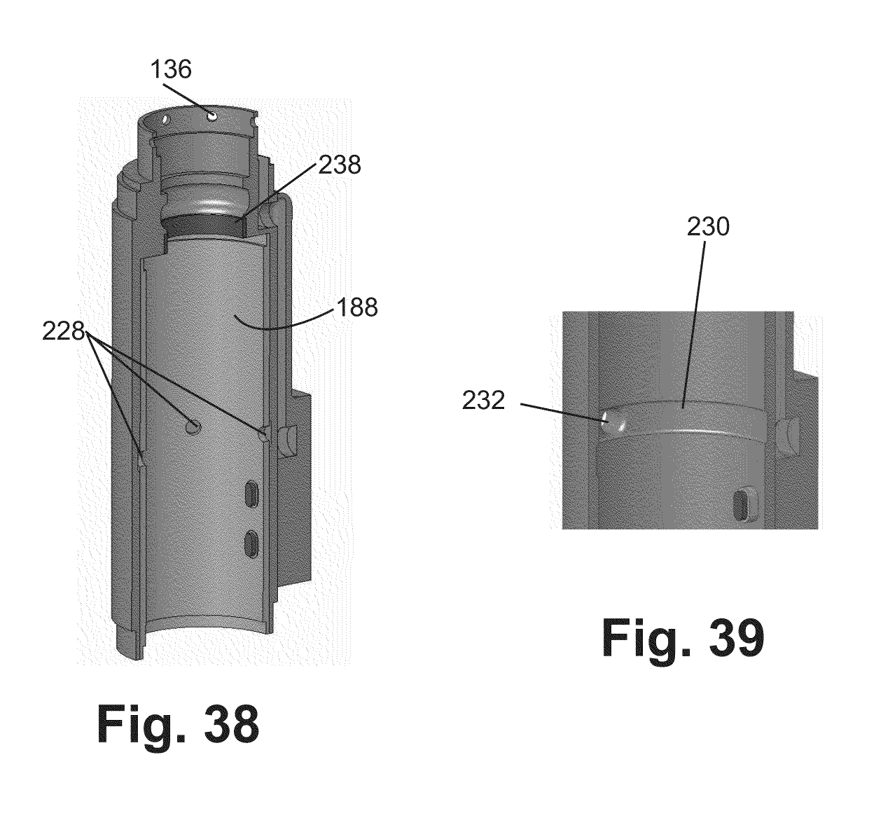

FIG. 36 illustrates a cutaway of the motor housing 52 with head removed to show the coolant flow through the motor and bearings. FIG. 37 shows the head 216, inverted with respect to the orientation of FIG. 36, to show the coolant channels 220 in the head. Coolant enters the electrical/coolant connector 62 via the coolant line connector 112c (see also FIGS. 10 and 11) and flows via an internal coolant line 111 (not visible in FIG. 36) to a coolant channel 113 formed by the housing and connector 62, into a port hole 234, through a channel 236 in the motor housing to holes 136. The holes 136 allow the coolant to enter the head 216 of the pump motor. In the head 216, the direction of coolant flow is reversed as the coolant flows through channels 220, shown in FIG. 37, and indicated in FIG. 36 by flow arrow 214. As shown in FIG. 37, the channels 220 in the head 216 guide coolant over the top of the main thrust bearing 222. From the head 216, coolant enters the drive shaft 208 (not shown in FIG. 36, but see FIG. 40) and flows to the hydraulic radial bearings, the lower of which was described above with respect to FIGS. 34 and 35. After passing through the annular plenum 212 and lower hydraulic radial bearing 204 as described above, coolant flows to the stator/rotor 224 spaces. It flows across gaps 226 in the canned stator windings and through holes 228 in the insulation 188, visible in FIG. 36 but more clearly shown in FIG. 38. After passing through the holes 228, the coolant enters a circumferential groove 230, shown in FIG. 39, in the main motor housing. The circumferential groove 230 collects the flow from all the holes 228 in the insulation and expels the coolant through nozzles 232 to mix with the RCS flow. In an alternative embodiment, the pump cooling system could be closed loop and the flow returned via another vessel penetration to a heat exchanger. Also shown in FIG. 38 is the graphite metal hydraulic bearing 244.

The upper portion of the pump motor assembly 52 and head 216 with coolant passages 220 is shown in FIGS. 40 (depicting the shutdown mode) and 41 (depicting the normal running mode). As described previously, the coolant from the electrical and coolant panel travels vertically upward via the channel 113 to a port hole 234 in the motor assembly 52. The coolant then travels through a channel 236 to radial holes 136 which align with the coolant passages 220 in the pump head 216. Flow reverses, shown by flow arrow 214, in the head as it flows through the radial coolant passages 220 and across the main thrust bearing 222, cooling it. The main thrust bearing 222 is a heavy duty mechanical thrust bearing of large diameter. It's service life is further extended by cooling it with the lowest temperature inlet cooling water. The radial channels 220 butt up against the top main thrust bearing surface 222 and the fluid in contact with the thrust bearing provides cooling.

With reference to FIG. 41, after flowing across the main thrust bearing, the coolant enters the drive shaft 208. There are holes 240 at the top/rear end of the shaft to feed coolant to the upper radial hydraulic bearing, in similar fashion to the holes 210 that serve the lower radial hydraulic bearing (see FIGS. 34 and 35). Coolant exits the holes 240 in the shaft, aided both by pressure and centrifugal force, and flows to an annular plenum 242. From the annular plenum 242, it flows in between the bearing surfaces of the upper radial hydraulic bearing 244. The coolant flows from the annular plenum through this gap and then downward to the stator space 224 and then out of the pump housing, as with the lower hydraulic bearing.

As with the lower mechanical radial bearing 200, (FIGS. 33-35), the pusher thrust of the shaft causes the inclined surfaces of the upper radial mechanical bearing 238 to separate, creating a gap, so that the upper radial mechanical bearing is also unloaded during normal operation. The rear radial mechanical bearing does not contact any thrust bearing like the front one. Only one startup thrust bearing is needed and it is in the front of the motor. The pusher thrust further causes the clutch plate 222a of the rotor to engage the lower plate 222b of the heavy duty mechanical main thrust bearing 222. A center hole in the clutch plate allows the coolant to flow into the main rotor shaft.

FIG. 42 shows the pump main rotor shaft 208 with impellor 60. As previously described, the drive shaft 208 is hollow to accept the coolant flow from the head of the motor. Visible in FIG. 42 are holes 240, 210 for centrifugal outflow to the annular plenums 242, 212 of the upper and lower hydraulic radial bearings (See FIGS. 40, 34). The radial graphite metal startup and thrust bearings 238, 200 are shown installed on the drive shaft 208. The impellor 60 is a four bladed axial flow type attached with keyed slot (not shown) and a rotor hub. However, other impeller designs are contemplated. As discussed above, the pump motor bearing incorporates mechanical bearings for short time duration startup and shutdown. During normal operation the mechanical bearings (radial and axial thrust) are disengaged and the loads are transferred to the hydraulic radial bearings 244, 204 and main thrust bearing, the clutch of which is labeled 222a. The mechanical radial bearings are high temperature bushings such as the Graphalloy brand graphite/metal alloy bearings. An alternate embodiment of the internal pump uses a hydraulic main thrust bearing as described below. Although this embodiment has been illustrated in a housing configured to attach to the jet pump diffuser, it could alternatively be used in the configuration without the jet pump.

An alternative to the mechanical thrust bearing is to use a hydraulic thrust bearing. An alternative to feeding the hydraulic radial bearings from plenums is to feed coolant to the bearing surfaces through small holes in the rotor at the surfaces of the hydraulic bearing. These embodiments will be illustrated with respect to a pump motor for use without a jet pump, but it is to be understood that they could be used with a jet pump. Additionally, the plenum style radial hydraulic bearings could be used with a hydraulic thrust bearing or the hole style radial hydraulic bearing used with a mechanical bearing. The embodiments shown are not meant to be limited to only the illustrative configuration.

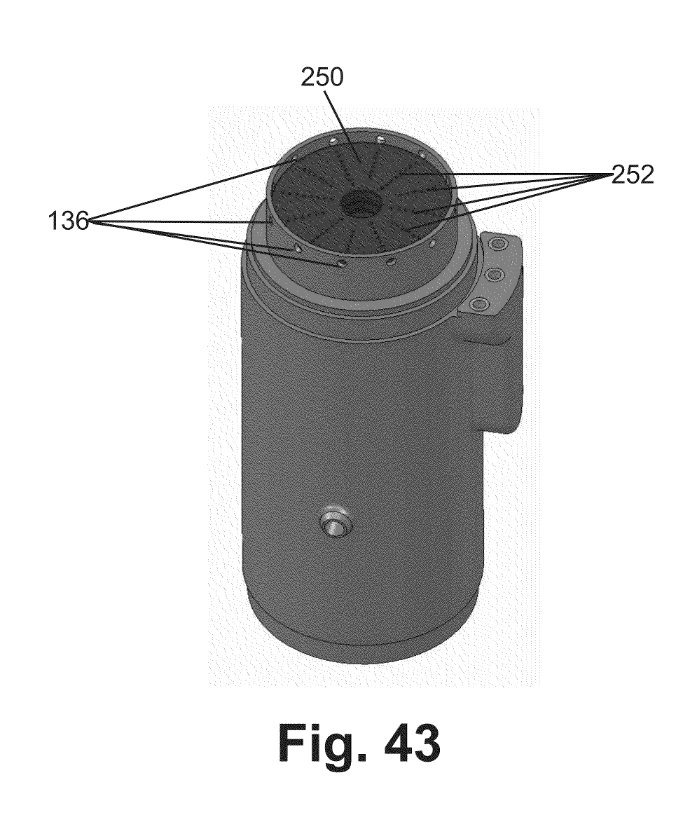

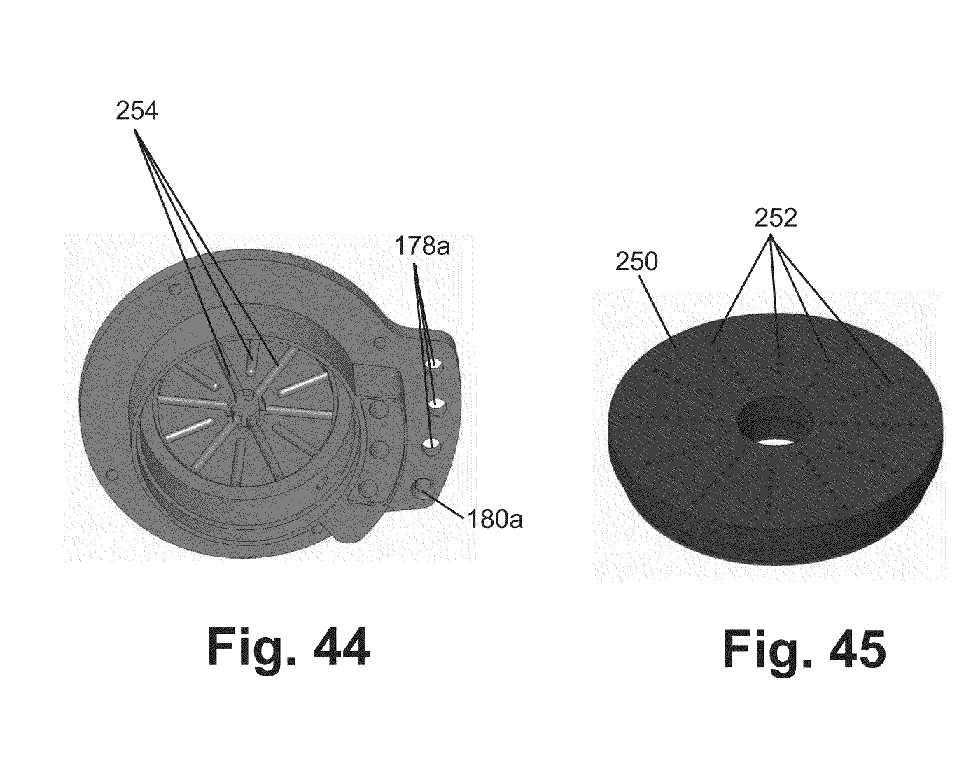

Illustrated in FIG. 43 is a hydraulic thrust bearing 250 shown mounted in a housing of an electrical driven hydraulic pump configured for use without a jet pump. The holes 136 in this embodiment provide not only cooling but lubrication for the hydraulic thrust bearing 250 as well. Unlike the previous embodiment, there are radial rows of axial holes 252 in the top plate of the hydraulic thrust bearing 250 that coincide with the radial grooves 254 in the head cap, shown in FIG. 44. The radial grooves 254 route the coolant water into the hydraulic main thrust bearing. This is similar to the mechanical bearing embodiment, except that with this concept the coolant is pumped into the hydraulic main thrust bearing through the radial rows of axial holes in the top disk of the bearing. The coolant is fed to the coolant line 180 (see FIG. 32) at coolant line connection 180a. The coolant flow from the line 180 to an internal channel in the pump head and then flows to the head cap grooves 254. From the grooves, the coolant flows through the axial holes 252 of the plate to create a thin film layer for the hydraulic thrust bearing 250. The coolant flow in the thin film layer gap is radially outward, through a gap at the outer edge of the lower bearing plate and to an annular space surrounding the mechanical radial startup bearing. There are a series of axial holes in the middle housing body to allow the hydraulic thrust bearing coolant to escape into the stator space of the pump motor. FIG. 45 is a view of the hydraulic thrust bearing 250 removed from the motor. FIG. 44 also shows the sockets 178a on top of the head cover for the electrical connectors 178 (see FIG. 32) on top of the pump plate.

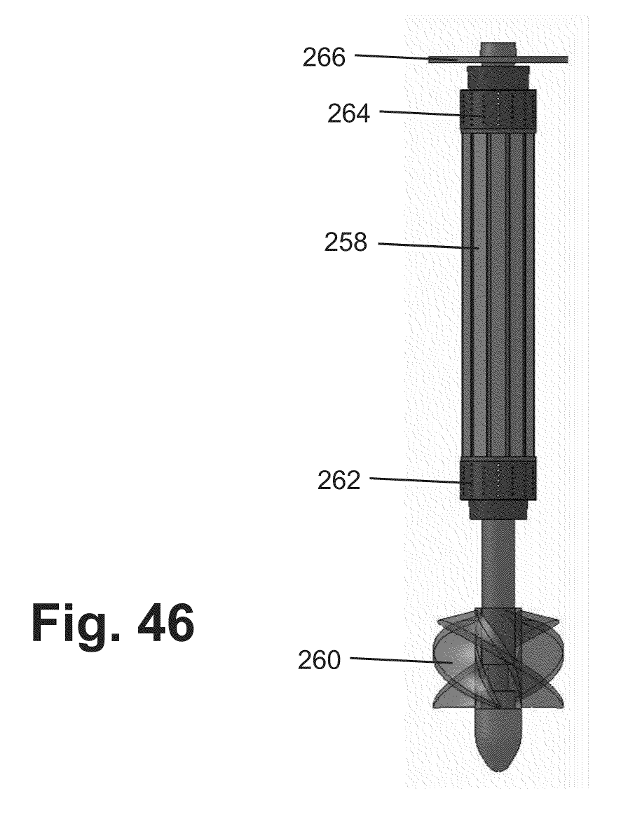

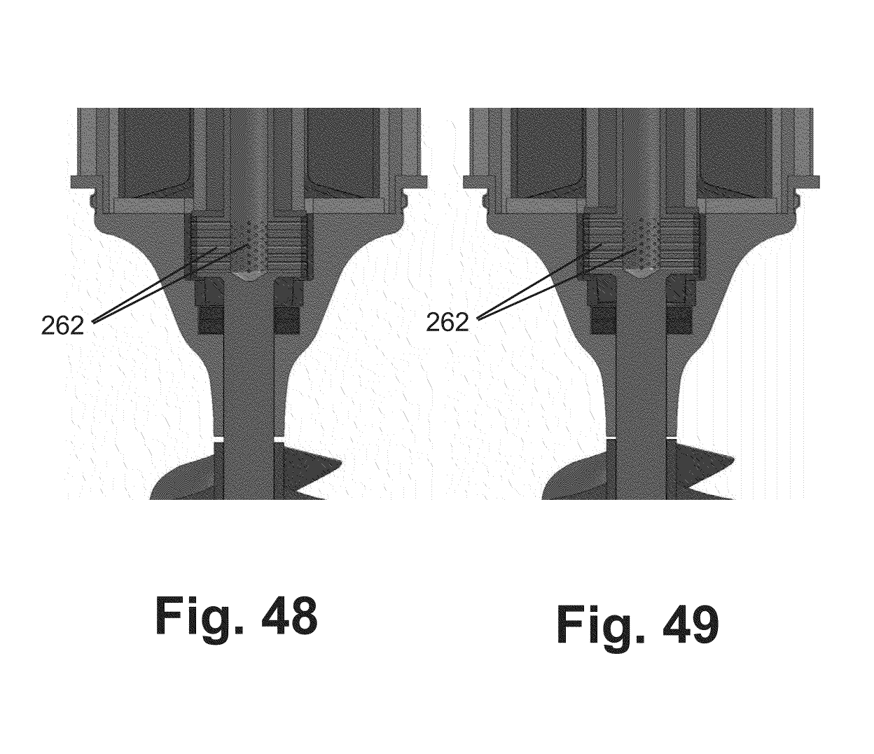

The main rotor shaft 258 with impellor 260 of an embodiment that uses a hydraulic thrust bearing is shown in FIG. 46. The centrifugal outflow holes 240, 210 of the above embodiment of the main shaft are replaced with many radial holes 262, 264 which feed coolant to a thin film in the bearing gap. In this embodiment, the radial outflow to the hydraulic bearing is direct to the bearing surface rather than from the bearing plenums shown in FIGS. 34/35 and FIGS. 40/41. FIG. 46 also shows the clutch 266 on the main rotor shaft 258 which engages the main hydraulic thrust bearing. An enlarged view of the lower bearing configuration is shown in FIG. 47. The radial hydraulic bearing is shown in cross section to reveal the many small radial holes 262 feeding the thin film layer of the bearing surface. The startup mechanical radial and startup mechanical thrust bearing configuration is the same as the previous embodiment. The position of the front bearing assembly of the main shaft during startup is shown in FIG. 48, and during normal operation is shown in FIG. 49. As in the previous embodiment, at startup, the inner bushing of the mechanical radial bearing contacts the startup thrust bearing. This also limits the reverse travel of the main shaft during startup and shutdown. During normal operation, the main shaft is displaced inward from the impellor thrust and hydraulic radial bearing is carrying the load and the startup radial and thrust bearings are inactive.

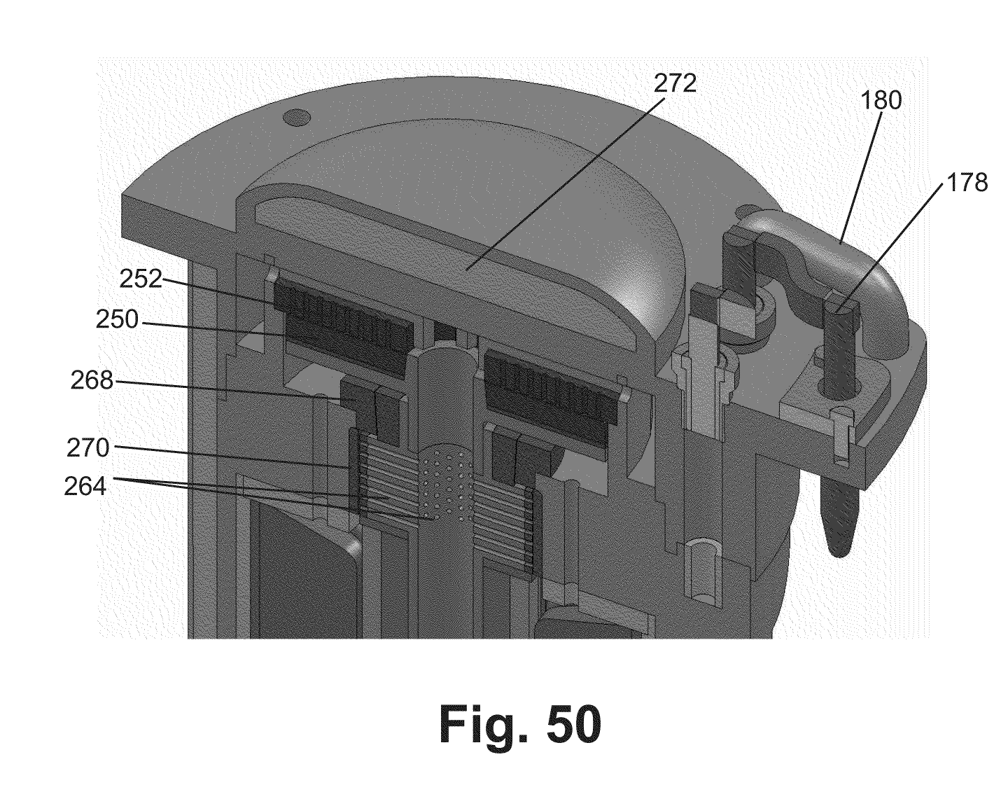

FIG. 50 shows the arrangement of the upper pump housing, which is similar to the pump housing of the previous embodiment. Coolant flow is directly to the pump head via the coolant line 180 rather than from an inlet panel on the side of the pump motor. The coolant line 180 is a cross-over pipe from the pump flange to the pump cover, which has a feed channel that empties into the annular head volume supplying the radial hydraulic bearing grooves. The upper hydraulic thrust bearing 250 is shown mounted in the main pump housing. Also shown is the startup radial bearing 268 and hydraulic radial bearing 270 with holes 264. The operation of both is similar to that of the lower radial bearings. One electrical line 178 is shown. There is a layer of insulation 272 on the top cover.

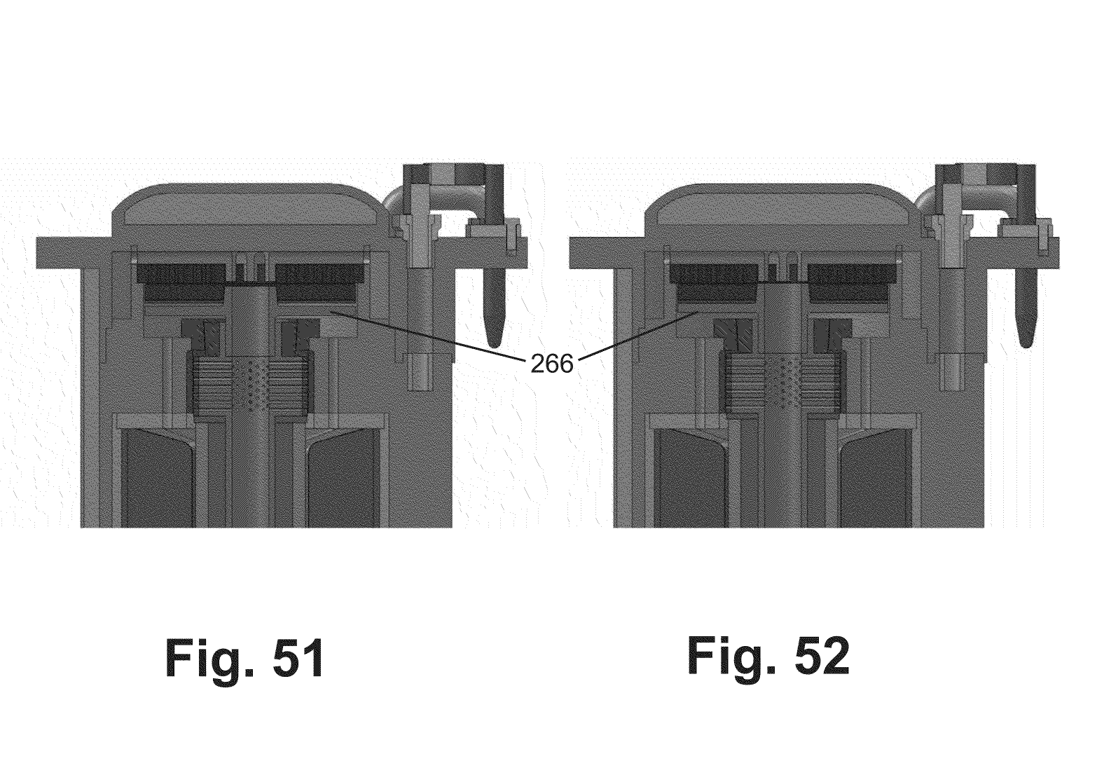

FIGS. 51 and 52 show the rear hydraulic and mechanical radial bearings, which operate on the same principle as the front radial bearings discussed previously, during startup (FIG. 51) and during normal operation (FIG. 52). The rear mechanical radial bearing disengages the friction surface during normal operation the same as the front bearing. However, the rear radial mechanical bearing does not contact any thrust bearing like the front one. As in the previous embodiment, only one startup thrust bearing is needed and it is in the front of the motor in this design. The clutch plate 266 on the main rotor shaft contacts the lower half of the main hydraulic thrust bearing. A center hole in the clutch plate allows the coolant to flow into the main rotor shaft for the hydraulic radial bearings. The coolant from the pump head flows outward through the centrifugal flow holes the same as for the front radial bearing discussed previously. The outward coolant flow to the bearing gap forms the thin film for the rear radial bearing the same as for the front bearing. However, the rear bearing coolant outflow flow is downward into the rotor/stator space and exits the pump housing as discussed previously across the gaps in the canned stator windings. Under normal operation, the entire main shaft assembly is supported on liquid films for the hydraulic radial bearings radially and from the main thrust bearing axially. This should give very long bearing life since there is no metal on metal friction with the radial hydraulic and axial thrust bearings. The mechanical radial bearings which do have friction surfaces are disengaged. Service life is further extended since the radial and main thrust hydraulic bearings are cooled by the lowest temperature inlet cooling water before it is heated by the pump motor stator winding and heat adsorption from the RCS.

The embodiments presented have numerous advantages, some of which are mentioned here. Because the jet pumps have no moving parts, they only need periodic inspection and replacement if structural defects are found. Inspection can be done in parallel with refueling so as to not extend the outage. The internal pumps and jet pumps are constructed with modular parts so they can be removed for replacement. Both top access and side access methods were developed although other methods are possible. The electrical and coolant connectors could be routed through the mid-flange and the connector panel would be on the top of the pump motor. Wet side internal connections would be required before removing the mid-flange. The pump motors could remain in place during refueling if the bearing replacement schedule deemed a low probability of the pump bearings failing for a particular refueling cycle outage.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
an integral pressurized water reactor (PWR) including:
a cylindrical pressure vessel,
a cylindrical central riser disposed coaxially inside the cylindrical pressure vessel wherein a downcomer annulus is defined between the cylindrical central riser and the cylindrical pressure vessel,
a nuclear core comprising a fissile material disposed in the cylindrical pressure vessel and immersed in primary coolant water, and
a steam generator disposed in the downcomer annulus; and
a reactor coolant pump (RCP) arranged inside the cylindrical pressure vessel to pump primary coolant water inside the cylindrical pressure vessel, the RCP including:
a jet pump having a jet pump nozzle, a jet pump suction inlet, and a diffuser section, the jet pump being disposed in the downcomer annulus,
and
a hydraulic pump configured to pump primary coolant into the jet pump nozzle wherein the hydraulic pump includes a canned electric motor mounted internally to the pressure vessel and an impeller in fluid communication with the jet pump nozzle.

2. The apparatus of claim 1, wherein the hydraulic pump and jet pump form a removable module disposed in the downcomer annulus.

3. The apparatus of claim 1 wherein the canned electric motor of the hydraulic pump is mounted above an annular pump plate disposed in the downcomer annulus and the jet pump is disposed in a mounting opening in the annular pump plate with the diffuser section arranged to discharge below the annular pump plate.

4. The apparatus of claim 3 wherein the annular pump plate is mounted to a mid-flange of the cylindrical pressure vessel disposed between an upper vessel portion of the cylindrical pressure vessel and a lower vessel portion of the cylindrical pressure vessel.

5. The apparatus of claim 3, wherein the jet pump nozzle discharges into a conical structure of the jet pump and the jet pump suction inlet is defined by an annular gap between the nozzle and the conical structure of the jet pump.

6. The apparatus of claim 3, wherein the annular pump plate comprises a manifold box having an annular flow distribution plenum in fluid communication with the jet pump suction inlet.

7. The apparatus of claim 6 wherein the manifold box comprises arcuate manifold box segments arranged to form the annular pump plate.

8. The apparatus of claim 7 wherein a plurality of gussets are disposed in the downcomer annulus and the manifold box segments are disposed between the gussets.

9. The apparatus of claim 6, wherein the jet pump passes through the manifold box and the jet pump includes a compression ring compressed between the jet pump and a perimeter of the mounting opening to seal the mounting opening.

10. The apparatus of claim 9, wherein the jet pump is secured to the manifold box by fasteners that are accessible from the suction side of the jet pump and is not secured to the annular pump plate by any fasteners that are not accessible from the suction side of the jet pump.

11. The apparatus of claim 1 wherein the jet pump operates with a mass flow ratio in the range 0.4 to 0.8.

12. The apparatus of claim 1 wherein motor stator windings of the canned electric motor are disposed in a wet can and are cooled by a cooling system flowing primary coolant water.

13. The apparatus of claim 12 wherein the external cooling system is an open-loop cooling system.

14. The apparatus of claim 12 wherein the external cooling system is a closed-loop cooling system.

15. The apparatus of claim 1 wherein the canned electric motor includes a drive shaft having holes and a primary coolant passageway, a mechanical startup radial bearing that is disengaged during motor operation by an axial shift of the rotating drive shaft, and a hydraulic radial bearing receiving coolant from a plenum which receives coolant from the holes in the drive shaft.

16. The apparatus of claim 15 having a mechanical thrust bearing.

17. The apparatus of claim 15 further including a hydraulic thrust bearing lubricated by holes in a plate of the hydraulic thrust bearing.

18. An apparatus comprising:
an integral pressurized water reactor (PWR) including:
a cylindrical pressure vessel,
a cylindrical central riser disposed coaxially inside the cylindrical pressure vessel wherein a downcomer annulus is defined between the cylindrical central riser and the cylindrical pressure vessel,
a nuclear core comprising a fissile material disposed in the cylindrical pressure vessel and immersed in primary coolant water;
a steam generator disposed in the downcomer annulus;
an annular pump plate disposed in the downcomer annulus;
a reactor coolant pump (RCP) mounted in an opening of the annular pump plate, the RCP including an internal canned electric motor disposed in the downcomer annulus and an impeller disposed in the downcomer annulus and operatively connected with the canned electric motor by a drive shaft; and
a flow distributor disposed in the downcomer annulus and supported by the annular pump plate, the flow distributor defining a fluid flow path from an inlet drawing primary coolant water from above the annular pump plate to an impeller inlet plenum containing the impeller of the RCP, the fluid flow path not passing through the canned electric motor.

19. The apparatus of claim 18 wherein the fluid flow path defined by the flow distributor includes two branches that discharge into the impeller inlet plenum on opposite sides of the impeller of the RCP.

20. The apparatus of claim 18 wherein the fluid flow path defined by the flow distributor includes a plurality of branches discharging into the impeller inlet plenum a different locations around the impeller of the RCP.

21. The apparatus of claim 18, wherein the RCP is secured in a pump mounting opening passing through the annular pump plate with a compression ring compressed between the RCP and an opening of the flow distributor.

22. The apparatus of claim 18, wherein the RCP is secured to the annular pump plate by fasteners that are accessible from a first side of the annular pump plate and is not secured to the annular pump plate by any fasteners that are not accessible from the first side of the pump plate.

23. The apparatus of claim 18 wherein the RCP further includes a mechanical bearing that is disengaged by a axial shift of the rotating drive shaft and a hydraulic bearing lubricated by primary coolant water.

24. An apparatus comprising:
a reactor coolant pump (RCP) including (i) a jet pump having an injector inlet, a pump inlet, and a diffuser with a jet pump discharge and (ii) an electrically driven hydraulic pump including an impeller disposed at the injector inlet and an electric motor connected with the impeller by a drive shaft.

25. The apparatus of claim 24 wherein the drive shaft lies along a centerline of the jet pump passing from the injector inlet to the jet pump discharge.

26. The apparatus of claim 25 wherein the impeller is disposed along the centerline of the jet pump between the injector inlet and the electric motor.

27. The apparatus of claim 24 further comprising:
a nuclear reactor including a nuclear core comprising fissile material disposed in a pressure vessel and immersed in primary coolant water;
wherein the RCP is disposed inside the pressure vessel with the electric motor disposed inside the pressure vessel.

28. An apparatus comprising:
a reactor coolant pump (RCP) including an impeller and an electric motor connected with the impeller by a drive shaft; and
a flow distributor defining an impeller plenum and a fluid flow path wherein the RCP is seated in the flow distributor with the impeller of the seated RCP disposed in the impeller plenum and with the fluid flow path extending from a fluid flow inlet to the impeller plenum wherein the fluid flow path passes alongside but not through the electric motor of the seated RCP.

29. The apparatus of claim 28 wherein the fluid flow path includes a plurality of branches passing alongside but not through the electric motor of the seated RCP and connecting with the impeller plenum at different locations around the impeller.

30. The apparatus of claim 28 further comprising:
a nuclear reactor including a nuclear core comprising fissile material disposed in a pressure vessel and immersed in primary coolant water;
wherein the RCP and the flow distributor are both disposed inside the pressure vessel and the electric motor of the RCP is disposed inside the pressure vessel.
